(19) United States
(12) Patent Application Publication
(10) Pub. No.: US 2019/0103212 A1
(43) Pub. Date: Apr. 4, 2019

(54) Circuit Apparatus and Power Conversion System

(71) Applicant: MITSUBISHI ELECTRIC CORPORATION, Chiyoda-ku, Tokyo (JP)

(72) Inventors: Kenta Fujii, Chiyoda-ku, Tokyo (JP); Koji Nakajima, Chiyoda-ku, Tokyo (JP); Takashi Kumagai, Chiyoda-ku, Tokyo (JP)

(73) Assignee: MITSUBISHI ELECTRIC CORPORATION, Chiyoda-ku, Tokyo (JP)

(21) Appl. No.: 16/095,110

(22) PCT Filed: May 9, 2017
(86) PCT No.: PCT/JP2017/017518

§ 371 Date: Oct. 19, 2018

(30) Foreign Application Priority Data
May 30, 2016 (JP) 2016-107234

(51) Int. Cl. H01F 27/22; H01F 27/24; H01F 27/28; H02M 3/335

(52) U.S. Cl. CPC H01F 27/22; H02M 3/33569; H01F 27/28; H01F 27/24

(57) ABSTRACT

A circuit apparatus includes: a core including a first core portion and a second core portion; and a first heat transfer member arranged between the first core portion and the second core portion. The first heat transfer member is in surface contact with a first side surface of the first core portion and a second side surface of the second core portion. The first heat transfer member is thermally connected to a coil. Thus, the rise in temperature of the core during operation of the circuit apparatuses can be more uniformly suppressed.

### TECHNICAL FIELD

The present invention relates to a circuit apparatus and a power conversion system.

### BACKGROUND ART

A circuit apparatus including a transformer and a smoothing capacitor known (see PTD 1). During operation of the circuit apparatus, the core of each of the transformer and the smoothing coil included in the circuit apparatus generates heat and increases in temperature. With the increase in temperature of the core, the losses at the core such as eddy-current losses and hysteresis losses increase. A circuit apparatus disclosed in PTD 1 includes: a core; a first heat dissipating member provided on the upper surface of the core; and a second heat dissipating member provided on the lower surface of the core. The first heat dissipating member and the second heat dissipating member dissipate the heat generated at the core during operation of the circuit apparatus, to the outside of the circuit apparatus.

### CITATION LIST

### Patent Document

PTD 1: Japanese Patent No. 5785363

### SUMMARY OF INVENTION

### Technical Problem

The first heat dissipating member and the second heat dissipating member, however, are not in contact with the region between the upper surface and the lower surface of the core. The first heat dissipating member and the second heat-dissipating member cannot satisfactorily dissipate the heat generated at the region between the upper surface and the lower surface of the core. Therefore, in the circuit apparatus disclosed in PTD 1, the rise in temperature of the core is not uniformly suppressed, and it is difficult to fully reduce the losses at the core.

An object of the present invention, which has been made in view of the above problem, is to provide a circuit apparatus and a power conversion system that can more uniformly suppress the rise in temperature of the core during operation of the circuit apparatus.

### Solution to Problem

A circuit apparatus and a power conversion system of the present invention include: a core including a first core portion and a second core portion; a coil surrounding at least a part of the core; a first heat transfer member arranged between the first core portion and the second core portion; and a heat dissipating member thermally connected to the first core portion, the second core portion, and the first heat transfer member. The first heat transfer member has a higher thermal conductivity than the core. The core includes a lower surface facing the heat dissipating member and an upper surface opposite to the lower surface. The first core portion includes a first side surface, the first side surface connecting the upper surface and the lower surface to each other and facing the first heat transfer member. The second core portion includes a second side so surface, the second side surface connecting the upper surface and the lower surface to each other and facing the first heat transfer member. The first heat transfer member is in surface contact with the first side surface and the second side surface. The first heat transfer member is thermally connected to the coil.

### Advantageous Effects of Invention

In the circuit apparatus and the power conversion system of the present invention, the first heat transfer member is in surface contact with the first side surface of the first core portion and the second side surface of the second core portion. The first heat transfer member is thermally connected to the coil. According to the circuit apparatus and the power conversion system of the present invention, the rise in temperature of the core during operation of the circuit apparatus can be more uniformly suppressed.

### BRIEF DESCRIPTION OF DRAWINGS

FIG. 1 is a circuit diagram of a power conversion system according to embodiment 1 of the present invention.

FIG. 2 is a schematic plan view of a circuit apparatus according embodiment 1 of the present invention.

FIG. 3 is a schematic cross-sectional view of a circuit apparatus according to embodiment 1 of the present invention along the cutting plane line III-III shown in FIG. 2, a schematic cross-sectional view of a circuit apparatus according to a variation of embodiment 3 of the present invention along the cutting plane line III-III shown in FIG. 12, a schematic cross-sectional view of a circuit apparatus according to embodiment 9 of the present invention along the cutting plane line III-III shown in FIG. 29, and a schematic cross-sectional view of a circuit apparatus according to embodiment 11 of the present invention along the cutting plane line III-III shown in FIG. 33.

FIG. 4 is a schematic cross-sectional view of a circuit apparatus according to embodiment 1 of the present invention along the cutting plane line IV-IV shown in FIG. 2, a schematic cross-sectional view of a circuit apparatus according to embodiment 3 of the present invention along the cutting plane line IV-IV shown in FIG. 9, a schematic cross-sectional view of a circuit apparatus according to a variation of embodiment 3 of the present invention along the cutting plane line IV-IV shown in FIG. 12, a schematic cross-sectional view of a circuit apparatus according to embodiment 9 of the present invention along the cutting plane line IV-IV shown in FIG. 29, and a schematic cross-sectional view of a circuit apparatus according to embodiment 11 of the present invention along the cutting plane line IV-IV shown in FIG. 33.

FIG. 5 is a schematic cross-sectional view of a circuit apparatus according to embodiment 1 of the present invention along the cutting plane line V-V shown in FIG. 2.

FIG. 6 is a schematic cross-sectional view of a circuit apparatus according to embodiment 1 of the present invention along the cutting plane line VI-VI shown in FIG. 2, a schematic cross-sectional view of a circuit apparatus according to embodiment 3 of the present invention along the cutting plane line VI-VI shown in FIG. 9, and a schematic cross-sectional view of a circuit apparatus according to a variation of embodiment 3 of the present invention along the cutting plane line VI-VI shown in FIG. 12.

FIG. 7 is a schematic cross-sectional view of a circuit apparatus according to embodiment 1 of the present invention along the cutting plane line VII-VII shown in FIG. 2, a schematic cross-sectional view of a circuit apparatus according to embodiment 3 of the present invention along the cutting plane line VII-VII shown in FIG. 9, and a schematic cross-sectional view of a circuit apparatus according to a variation of embodiment 3 of the present invention along the cutting plane line VII-VII shown in FIG. 12.

FIG. 8 is a schematic cross-sectional view of a circuit apparatus according to embodiment 2 of the present invention.

FIG. 9 is a schematic plan view of a circuit apparatus according to embodiment 3 of the present invention.

FIG. 10 is a schematic cross-sectional view of a circuit apparatus according to embodiment 3 of the present invention along the cutting plane line X-X shown in FIG. 9.

FIG. 11 is a schematic cross-sectional view of a circuit apparatus according to embodiment 3 of the present invention along the cutting plane line XI-XI shown in FIG. 9.

FIG. 12 is a schematic plan view of a circuit apparatus according to a variation of embodiment 3 of the present invention.

FIG. 13 is a schematic cross-sectional view of a circuit apparatus according to a variation of embodiment 3 of the present invention along the cutting plane line XIII-XIII shown in FIG. 12.

FIG. 14 is a schematic plan view of a circuit apparatus according to embodiment 4 of the present invention.

FIG. 15 is a schematic cross-sectional view of a circuit apparatus according to embodiment 4 of the present invention along the cutting plane line XV-XV shown in FIG. 14.

FIG. 16 is a schematic cross-sectional view of a circuit apparatus according to embodiment 4 of the present invention along the cutting plane line XVI-XVI shown in FIG. 14.

FIG. 17 is a schematic cross-sectional view of a circuit apparatus according to embodiment 4 of the present invention along the cutting plane line XVII-XVII shown in FIG. 14, a schematic cross-sectional view of a circuit apparatus according to embodiment 6 of the present invention along the cutting plane line XVII-XVII shown in FIG. 12, a schematic cross-sectional view of a circuit apparatus according to embodiment 7 of the present invention along the cutting plane line XVII-XVII shown in FIG. 25, and a schematic cross-sectional view of a circuit apparatus according to embodiment 8 of the present invention along the cutting plane line XVII-XVII shown in FIG. 27.

FIG. 18 is a schematic cross-sectional view of a circuit apparatus according to embodiment 4 of the present invention along the cutting plane line XVIII-XVIII shown in FIG. 14, a schematic cross-sectional view of a circuit apparatus according to embodiment 6 of the present invention along the cutting plane line XVIII-XVIII shown in FIG. 22, a schematic cross-sectional view of a circuit apparatus according to embodiment 7 of the present invention along the cutting plane line XVIII-XVIII shown in FIG. 25, and a schematic cross-sectional view of a circuit apparatus according to embodiment 8 of the present invention along the cutting plane line XVIII-XVIII shown in FIG. 27.

FIG. 19 is a schematic plan view of a circuit apparatus according to embodiment 5 of the present invention.

FIG. 20 is a schematic cross-sectional view of a circuit apparatus according to embodiment 5 of the present invention along the cutting plane line XX-XX shown in FIG. 19.

FIG. 21 is a schematic cross-sectional view of a circuit apparatus according to embodiment 5 of the present invention along the cutting plane line XXI-XXI shown in FIG. 19.

FIG. 22 is a schematic plan view of a circuit apparatus according to embodiment 6 of the present invention.

FIG. 23 is a schematic cross-sectional view of a circuit apparatus according to embodiment 6 of the present invention along the cutting plane line XXIII-XXIII shown in FIG. 22.

FIG. 24 is a schematic cross-sectional view of a circuit apparatus according to embodiment 6 of the present invention along the cutting plane line XXIV-XXIV shown in FIG. 22.

FIG. 25 is a schematic plan view of a circuit apparatus according to embodiment 7 of the present invention.

FIG. 26 is a schematic cross-sectional view of a circuit apparatus according to embodiment 7 of the present invention along the cutting plane line XXVI-XXVI shown in FIG. 25, and a schematic cross-sectional view of a circuit apparatus according to embodiment 14 of the present invention along the cutting plane line XXVI-XXVI shown in FIG. 39.

FIG. 27 is a schematic plan view of a circuit apparatus according to embodiment 8 of the present invention.

FIG. 28 is a schematic cross-sectional view of a circuit apparatus according to embodiment 8 of the present invention along the cutting plane line XXVIII-XXVIII shown in FIG. 27, and a schematic cross-sectional view of a circuit apparatus according to embodiment 15 of the present invention along the cutting plane line XXVIII-XXVIII shown in FIG. 42.

FIG. 29 is a schematic plan view of a circuit apparatus according to embodiment 9 of the present invention.

FIG. 30 is a schematic cross-sectional view of a circuit apparatus according to embodiment 9 of the present invention along the cutting plane line XXX-XXX shown in FIG. 29, a schematic cross-sectional view of a circuit apparatus according to embodiment 10 of the present invention along the cutting plane line XXX-XXX shown in FIG. 32, a schematic cross-sectional view of a circuit apparatus according to embodiment 11 of the present invention along the anting plane line XXX-XXX shown in FIG. 33, a schematic cross-sectional view of a circuit apparatus according to embodiment 12 of the present invention along the cutting plane line XXX-XXX shown in FIG. 36, and a schematic cross-sectional view of a circuit apparatus according to embodiment 13 of the present invention along the cutting plane line XXX-XXX shown in FIG. 37.

FIG. 31 is a schematic cross-sectional view of a circuit apparatus according to embodiment 9 of the present invention along the cutting plane line XXXI-XXXI shown in FIG. 29, a schematic cross-sectional view of a circuit apparatus according to embodiment 10 of the present invention along the cutting plane line XXXI-XXXI shown in FIG. 32, and a schematic cross-sectional view of a circuit apparatus according to embodiment 13 of the present invention along the cutting plane line XXXI-XXXI shown in FIG. 37.

FIG. 32 is a schematic plane view of a circuit apparatus according to embodiment 10 of the present invention.

FIG. 33 is a schematic plan view of a circuit apparatus according to embodiment 11 of the present invention.

FIG. 34 is a schematic cross-sectional view of a circuit apparatus according to embodiment 11 of the present invention along the cutting plane line XXXIV-XXXIV shown in FIG. 33, and a schematic cross-sectional view of a circuit apparatus according to embodiment 12 of the present invention along the cutting plane line XXXIV-XXXIV shown in FIG. 36.

FIG. 35 is a schematic cross-sectional view of a circuit apparatus according to embodiment 11 of the present invention along the cutting plane line XXXV-XXXV shown in FIG. 33, and a schematic cross-sectional view of a circuit apparatus according to embodiment 12 of the present invention along the cutting plane line XXXV-XXXV shown in FIG. 36.

FIG. 36 is a schematic plan view of a circuit apparatus according to embodiment 12 of the present invention.

FIG. 37 is a schematic plan view of a circuit apparatus according to embodiment 13 of the present invention.

FIG. 38 is a schematic cross-sectional view of a circuit apparatus according to embodiment 13 of the present invention along the cutting plane line XXXVIII-XXXVIII shown in FIG. 37.

FIG. 39 is a schematic cross-sectional view of a circuit apparatus according to embodiment 14 of the present invention.

FIG. 40 is a schematic cross-sectional view of a circuit apparatus according to embodiment 14 of the present invention along the cutting plane line XL-XL shown in FIG. 39, and a schematic cross-sectional view of a circuit apparatus according to embodiment 15 of the present invention along the cutting plane line XLI-XLI shown in FIG. 42.

FIG. 41 is a schematic cross-sectional view of a circuit apparatus according to embodiment 14 of the present invention along the cutting plane line XLI-XLI shown in FIG. 39, and a schematic cross-sectional view of a circuit apparatus according to embodiment 15 of the present invention along the cutting plane line XLI-XLI shown in FIG. 42.

FIG. 42 is a schematic plan view of a circuit apparatus according to embodiment 15 of the present invention.

FIG. 43 is a schematic cross-sectional view of a circuit apparatus according to embodiment 15 of the present invention along the cutting plane line XLIII-XLIII shown in FIG. 42.

FIG. 44 is a schematic cross-sectional view of a power conversion system and a circuit apparatus according to embodiment 16 of the present invention.

FIG. 45 is a schematic cross-sectional view of a circuit apparatus according to embodiment 17 of the present invention.

FIG. 46 is a schematic cross-sectional view of a circuit apparatus according to embodiment 17 of the present invention.

FIG. 47 is a schematic plane view of a circuit apparatus according to embodiment 18 of the present invention.

FIG. 48 is a schematic cross-sectional view of a circuit apparatus according to embodiment 18 of the present invention along the cutting plane line XLVIII-XLVIII shown in FIG. 47.

FIG. 49 is a schematic cross-sectional view of a circuit apparatus according to embodiment 18 of the present invention along the cutting-plane line IL-IL shown in FIG. 47.

FIG. 50 is a schematic cross-sectional view of a circuit apparatus according to embodiment 18 of the present invention along the cutting plane line L-L shown in FIG. 47.

FIG. 51 is a schematic cross-sectional view of a circuit apparatus according to embodiment 18 of the present invention along the cutting plane line LI-LI shown in FIG. 47.

FIG. 52 is a schematic cross-sectional view of a circuit apparatus according to embodiment 18 of the present invention along the cutting plane line LII-LII shown in FIG. 47.

FIG. 53 is a schematic plan view of a circuit apparatus according to embodiment 19 of the present invention.

FIG. 54 is a schematic cross-sectional view of a circuit apparatus according to embodiment 19 of the present invention along the cutting plane line LIV-LIV shown in FIG. 53.

FIG. 55 is a schematic cross-sectional view of a circuit apparatus according to embodiment 19 of the present invention along the cutting plane line LV-LV shown in FIG. 53.

FIG. 56 is a schematic cross-sectional view of a circuit apparatus according to embodiment 19 of the present invention along the cutting plane line LVI-LVI shown in FIG. 53.

FIG. 57 is a schematic cross-sectional view of a circuit apparatus according to embodiment 19 of the present invention along the cutting plane line LVII-LVII shown in FIG. 53.

FIG. 58 is a schematic cross-sectional view of a circuit apparatus according to embodiment 19 of the present invention along the cutting plane line LVIII-LVIII shown in FIG. 53.

### DESCRIPTION OF EMBODIMENTS

Embodiments of the present invention are described hereinafter. Identical components are identically denoted, and the explanation thereof is not repeated.

### Embodiment 1

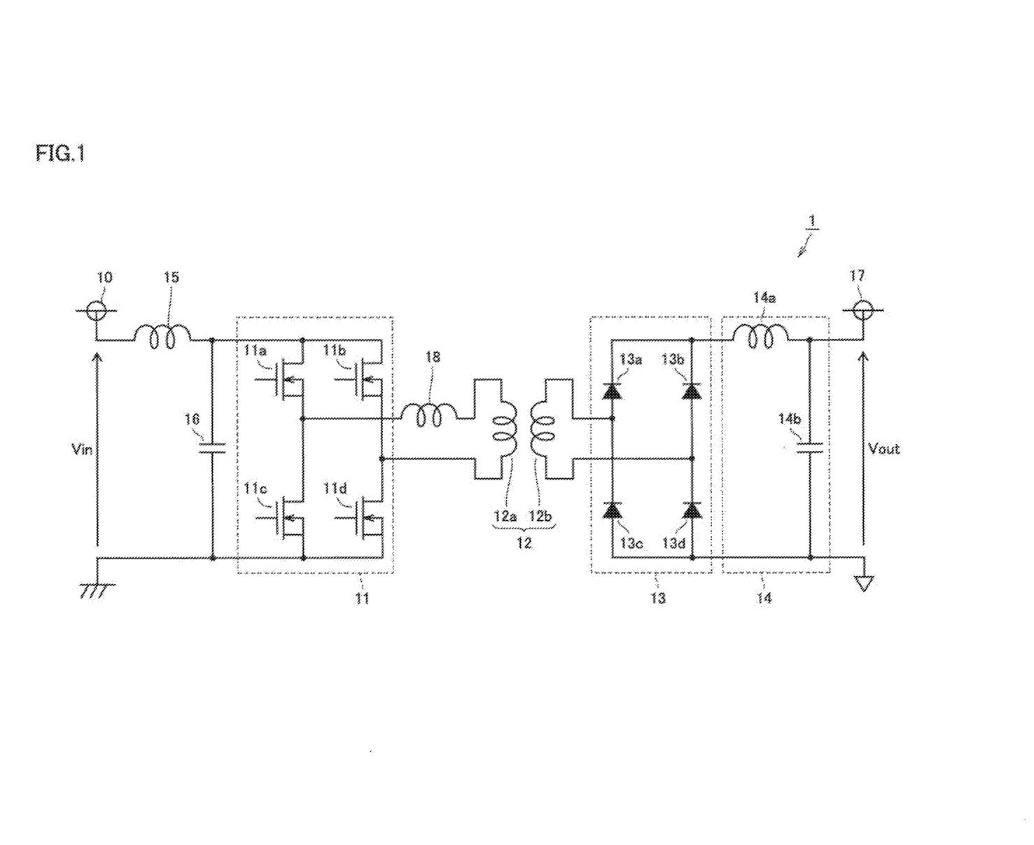

With reference to FIG. 1, an example circuit configuration of a power conversion system 1 in the present embodiment is described. Power conversion system 1 in the present embodiment may be an automotive DC-DC converter. Power conversion system 1 includes an input terminal 10, an inverter circuit 11 connected to input terminal 10, a transformer 12 connected to inverter circuit 11, a rectifier circuit 13 connected to transformer 12, a smoothing circuit 14 connected to rectifier circuit 13, and an output terminal 17 connected to smoothing circuit 14. Power conversion system 1 may further include a resonance coil 15 between input terminal 10 and inverter circuit 11. Power conversion system 1 may further include a capacitor 16 connected in parallel to inverter circuit 11. Power conversion system 1 may further include a filter coil 18 between inverter circuit 11 and transformer 12.

Inverter circuit 11 includes primary-side switching elements 11a, 11b, 11c, 11d. Transformer 12 is constituted of a primary-side coil conductor 12a connected to inverter circuit 11, and a secondary-side coil conductor 12b magnetically coupled to primary-side coil conductor 12a. Secondary-side coil conductor 12b is connected to rectifier circuit 13. Rectifier circuit 13 includes secondary-side switching elements 13a, 13b, 13c, 13d. Smoothing circuit 14 includes a smoothing coil 14a and a capacitor 14b. Each of primary-side switching elements 11a, 11b, 11c, 11d and secondary-side switching elements 13a, 13b, 13c, 13d may be, for example, a metal-oxide-semiconductor field effects transistor (MOSFET) or an insulated gate bipolar transistor (IGBT).

Power conversion system 1 in the present embodiment may convert a DC voltage of, for example, about 100 to 600 V inputted to input terminal 10 into a DC voltage of about 12 to 16 V, and output the converted DC voltage from output terminal 17. Specifically, a high PC voltage inputted to input terminal 10 is converted into a first AC voltage by inverter circuit 11. The first AC voltage is converted into a second AC voltage that is lower than the first AC voltage by transformer 12. The second AC voltage is rectified by rectifier circuit 13. Smoothing circuit 14 smoothes the voltage outputted from rectifier circuit 13, and outputs a low DC voltage to output terminal 17.

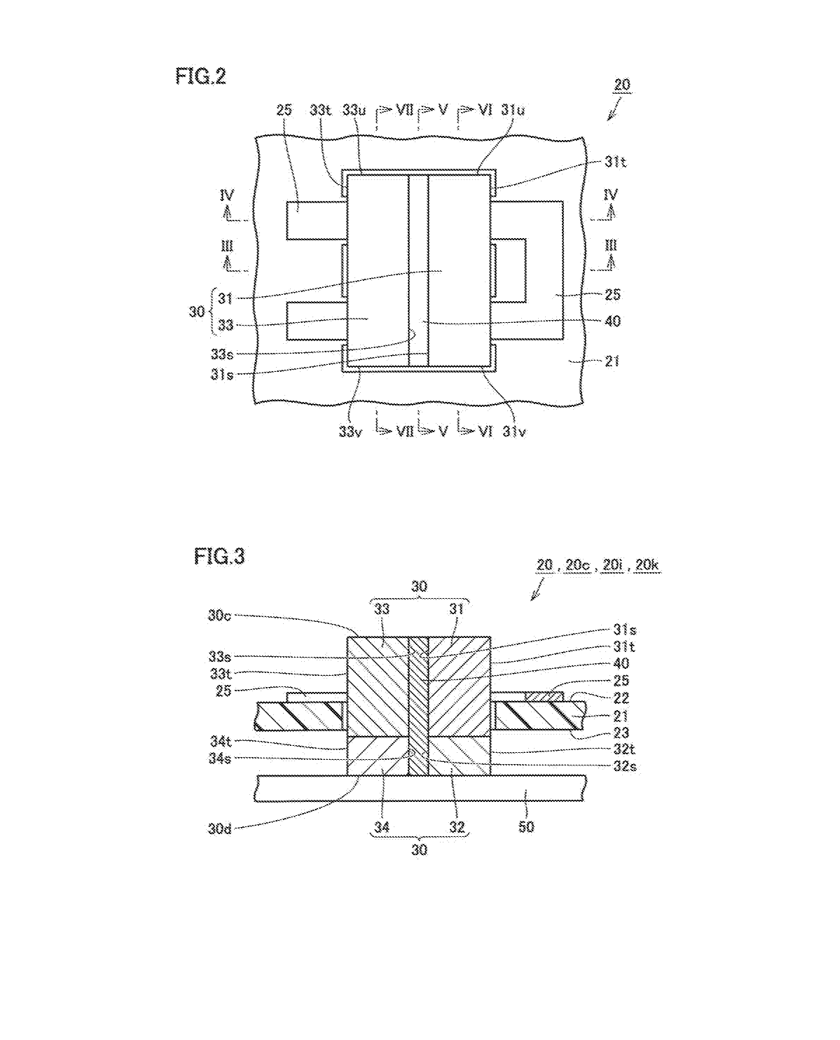

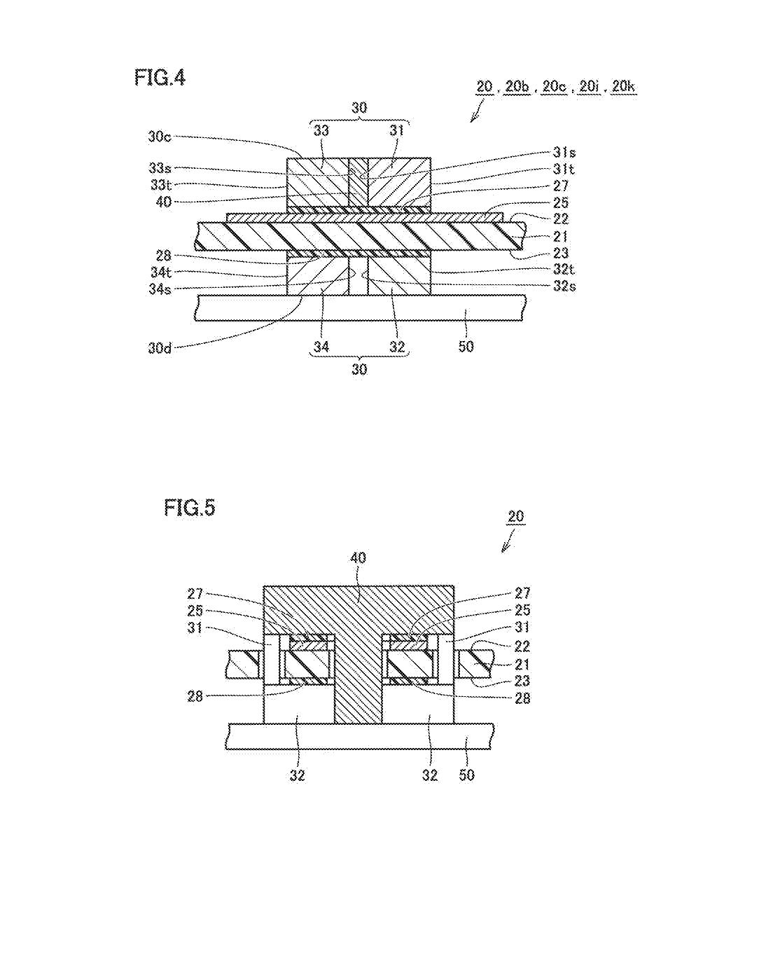

With reference to FIG. 2 to FIG. 7, a circuit apparatus 20 in the present embodiment is described. A part of power conversion system 1 that includes smoothing coil 14a may be circuit apparatus 20 in the present embodiment. Circuit apparatus 20 in the present embodiment may be a power component, such as transformer 12, resonance coil 15, filter coil 18, a reactor, or a motor; or may be an electromagnetic noise reduction component with a ring-shaped ferrite core.

Circuit apparatus 20 in the present embodiment mainly includes a core 30, a coil 25, a first heat transfer member 40, and a heat dissipating member 50. Circuit apparatus 20 in the present embodiment may further include second heat transfer members 27, 28 and a first substrate 21.

Core 30 includes a lower surface 30d and an upper surface 30c opposite to lower surface 30d. Lower surface 30d of core 30 faces heat dissipating member 50. Lower surface 30d of core 30 may be in contact with heat dissipating member 50. Core 30 is placed on heat dissipating member 50. The heat generated at core 30 during operation of circuit apparatus 20 is transferred from core 30 to heat dissipating member 50 and is dissipated from heat dissipating member 50 to the outside of circuit apparatus 20. Core 30 may be, for example, a ferrite core (e.g. Mn—Zn ferrite or Ni—Zn ferrite), an amorphous core, or an iron dust core.

Core 30 includes a first core portion (31, 32) and a second core portion (33, 34). Lower surface 30d of core 30 may be constituted of the lower surface of first core portion (31, 32) and the lower surface of second core portion (33, 34). The lower surface of first core portion (31, 31) and the lower surface of second core portion (33, 34) face heat dissipating member 50. The lower surface of first core portion (31, 32) and the lower surface of second core portion (33, 34) may be in contact with heat dissipating member 50. First core portion (31, 32) and second core portion (33, 34) are placed on heat dissipating member 50. Upper surface 30c of core 30 may be constituted of the upper surface of first core portion (31, 32) and the upper surface of second core portion (33, 34). Each of first core portion (31, 32) and second core portion (33, 34) may have a rectangular parallelepiped shape or other shapes.

First core portion (31, 32) includes a first side surface (31s, 32s) connecting upper surface 30c and lower surface 30d to each other and facing first heat transfer member 40. First side surface (31s, 32s) is adjacent to upper surface 30c and lower surface 30d. Second core portion (33, 34) includes a second side surface (33s, 34s) connecting upper surface 30c and lower surface 30d to each other and facing first heat transfer member 40. Second side surface (33s, 34s) is adjacent to upper surface 30c and lower surface 30d. First core portion (31, 32) may include a third side surface (31t, 32t) connecting upper surface 30c and lower surface 30d to each other and being opposite to first side surface (31s, 32s). Second core portion (33, 34) may include a fourth side surface (33t, 34t) connecting upper surface 30c and lower surface 30d to each other and being opposite to second side surface (33s, 34s).

First core portion (31, 32) may include a fifth side surface (31u, 32u) connecting first side surface (31s, 32s) and third side surface (31t, 32t) to each other, and a sixth side surface (31v, 32v) connecting first side surface (31s, 32s) and third side surface (31t, 32t) to each other and being opposite to fifth side surface (31u, 32u). Second core portion (33, 34) may include a seventh side surface (33u, 34u) connecting second side surface (33s, 34s) and fourth side surface (33t, 34t) to each other, and an eighth side surface (33v, 34v) connecting second side surface (33s, 34s) and fourth side surface (33t, 34t) to each other and being opposite to seventh side surface (33u, 34u). Seventh side surface (33u, 34u) is adjacent to fifth side surface (31u, 32u). Eighth side surface (33v, 34v) is adjacent to sixth side surface (31v, 32v).

First core portion (31, 32) may include a first sub-core portion 31 and a second sub-core portion 32. First sub-core portion 31 includes side surface 31s facing first heat transfer member 40, and side surface 31t opposite to side surface 31s. First sub-core portion 31 further includes side surface 31u connecting side surface 31s and side surface 31t to each other, and side surface 31v connecting side surface 31s and side surface 31t to each other and being opposite to side surface 31u. Second sub-core portion 32 includes side surface 32s facing first heat transfer member 40, and side surface 32t opposite to side surface 32s. Second sub-core portion 32 further includes side surface 32u connecting side surface 32s and side surface 32t to each other, and side surface 32v connecting side surface 32s and side surface 32t to each other and being opposite to side surface 32u. Fifth side surface (31u, 32u) of first core portion (31, 32) includes side surface 31u of first sub-core portion 31, and side surface 32u of second sub-core portion 32. Sixth side surface (31v, 32v) of first core portion (31, 32) includes side surface 31v of first sub-core portion 31, and side surface 32v of second sub-core portion 32.

Second core portion (33, 34) may include a third sub-core portion 33 and a fourth sub-core portion 34. Third sub-core portion 33t includes side surface 33s facing first heat transfer member 40, and side surface 33t opposite to side surface 33s. Third sub-core portion 33 further includes side surface 33u connecting side surface 33s and side surface 33t to each other, and side surface 33v connecting side surface 33s and side surface 33t to each other and being opposite to side surface 33u. Fourth sub-core: portion 34 includes side surface 34s feeing first heat transfer member 40, and side surface 34t opposite to side surface 34s. Fourth sub-core portion 34 further includes side surface 34u connecting side surface 34s and side surface 34t to each other, and side surface 34v connecting side surface 34s and side surface 34t to each other and being opposite to side surface 34u.

Seventh side surface (33u, 34u) of second core portion (33, 34) includes side surface 33u of third sub-core portion 33, and side surface 34u of fourth sub-core portion 34. Eighth side surface (33v, 34v) of second core portion (33, 34) includes side surface 33v of third sub-core portion 33, and side surface 34v of fourth sub-core portion 34. Side surface 33u of third sub-core-portion 33 is adjacent to side surface 31u of first sub-core portion 31. Side surface 33v of third sub-core portion 33 is adjacent to side surface 31v of first sub-core portion 31. Side surface 34u of fourth sub-core portion 34 is adjacent to side surface 32u of second sub-core portion 32 Side surface 34v of fourth sub-core portion 34 is adjacent to side surface 32v of second sub-core portion 32.

Lower surface 30d of core 30 may be constituted of the lower surface of second sub-core portion 32 and the lower surface of fourth sub-core portion 34. The lower surface of second sub-core portion 32 and the lower surface of fourth sub-core portion 34 face heat dissipating member 50. The lower surface of second sub-core portion 32 and the lower surface of fourth sub-core portion 34 may be in contact with heat dissipating member 50. Upper surface 30c of core 30 may be constituted of the upper surface of first sub-core portion 31 and the upper surface of third sub-core portion 33.

Each of first core portion (31, 32) and second core portion (33, 34) may be an EI type cote. Each of first sub-core portion 31 and third sub-core portion 33 may have an E shape, and each of second sub-core portion 32 and fourth sub-core portion 34 may have an I shape. Each of first core portion (31, 32) and second core portion (33, 34) may be an EE type core, a U type core, an EER type core, or an ER type core. Core 30 may surround a part of coil 25. First sub-core portion 31 and second sub-core portion 32 may surround a part of coil 25. Third sub-core portion 33 and fourth sub-core portion 34 may surround a part of coil 25.

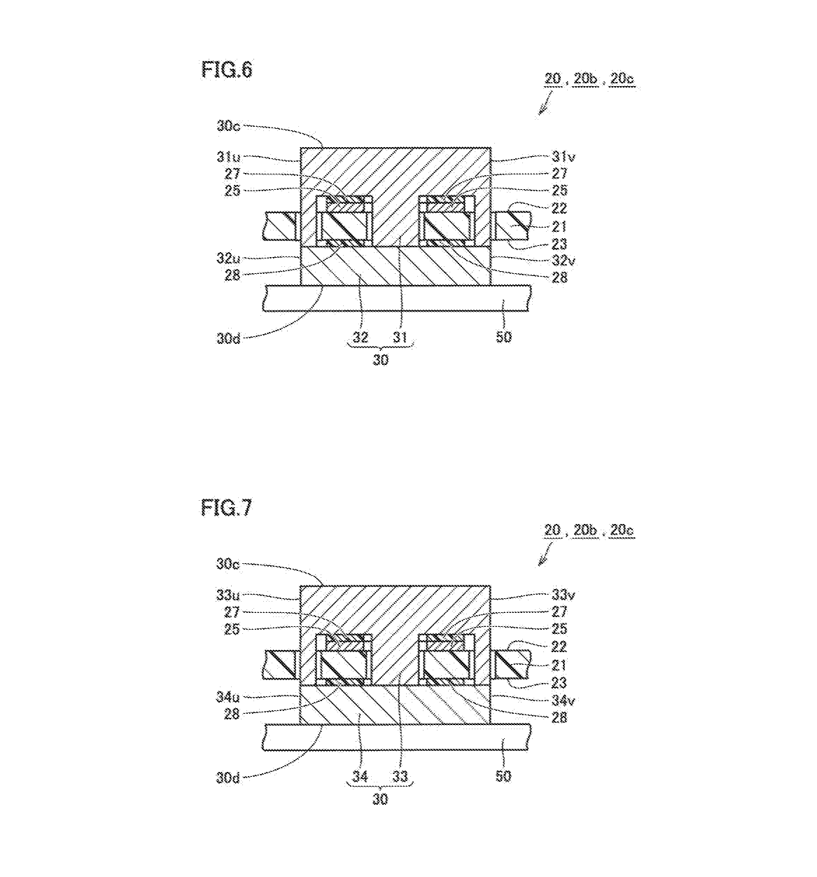

With reference to FIG. 2, FIG. 6, and FIG. 7, coil 25 surrounds at least a part of core 30. The state in which coil 25 surrounds at least a part of core 30 refers to the state in which coil 25 is wound around at least a part of core 30, a half turn or more. A part of coil 25 may be sandwiched between first sub-core portion 31 and second sub-core portion 32, and between third sub-core portion 33 and fourth sub-core portion 34.

Coil 25 may be a thin-film coil pattern. Coil 25 may be supported by first substrate 21. Coil 25 may be provided on a front side 22 of first substrate 21. Coil 25 may be a thin conductor layer having a thickness of, for example, 100 μm. Coil 25 may be a winding. Circuit apparatus 20 does not necessarily have to include first substrate 21, and coil 25 does not necessarily have to be supported by first substrate 21. Coil 25 is constituted of a material that has a lower electric resistivity than first substrate 21. Coil 25 may be constituted of a metallic material, such as copper (Cu), gold (An), a copper (Cu) alloy, a nickel (Ni) alloy, a gold (Au) alloy, or a silver (Ag) alloy.

First heat transfer member 40 has a higher thermal conductivity than core 30. First heat transfer member 40 has a higher thermal conductivity than first substrate 21. First heat transfer member 40 may have a thermal conductivity of 0.1 W/(m·K) or more, preferably 1.0 W/(m·K) or more, more preferably 10.0 W/(m·K) or more. First heat transfer member 40 may have rigidity or may have flexibility. First heat transfer member 40 may have elasticity. First heat transfer member 40 may be constituted of a metal such as Copper (Cu), aluminum (Al), iron (Fe), an iron (Fe) alloy (e.g. SUS304), a copper (Cu) alloy (e.g. phosphor bronze), or an aluminum (Al) alloy (e.g. ADC12). First heat transfer member 40 may be constituted of a resin material, such as polyphenylene sulfide (PPS) or polyether ether ketone (PEEK), containing a thermally conductive filler.

First heat transfer member 40 is arranged between first core portion (31, 32) and second core portion (33, 34). First heat transfer member 40 is thermally connected to first core portion (31, 32) and second core portion (33, 34). In the present description, the state in which two members are thermally connected to each other includes the following two meanings:

the first meaning is that the two members are in direct contact with each other, thus forming a heat conducting path between the two members; and

the second meaning is that a heat transfer member other than the two members is sandwiched between the two members, thus forming a heat conducting path between the two members with the heat transfer member being interposed therebetween. First heat transfer member 40 is in surface contact with first side surface (31s, 32s) and second aide surface (33s, 34s). First heat transfer member 40 may be in direct contact with first side surface (31s, 32s) and second side surface (33s, 34s), or may be in contact with them with a thermally conductive adhesive member being interposed.

First heat transfer member 40 may be in contact with first side surface (31s, 32s) at 5% or more of the area of first side surface (31s, 32s), preferably 20% or more, more preferably 50% or more. First heat transfer member 40 may be in contact with the whole area of first side surface (31s, 32s) of first core portion (31, 32). First heat transfer member 40 may be in contact with second side surface (33s, 34s) at 5% or more of the area of second side surface (33s, 34s), preferably 20% or more, more preferably 50% or more. First heat transfer member 40 may be in contact with the whole area of second side surface (33s, 34s) of second core portion (33, 34). The heat generated at core 30 during operation of circuit apparatus 20 is transferred from first heat transfer member 40 to heat dissipating member 50.

Heat dissipating member 50 is thermally connected to first heat transfer member 40. The heat generated at core 30 during operation of circuit apparatus 20 can be dissipated to the outside of circuit apparatus 20 through first heat transfer member 40 and heat dissipating member 50. Heat dissipating member 50 may be in contact with first heat transfer member 40.

First heat transfer member 40 may be fixed to heat dissipating member 30 by fixation, such as gluing, welding, and swaging. First heat transfer member 40 may be fixed to heat dissipating member 50 by fitting a part of first heat transfer member 40 into a groove in heat dissipating member 50. First heat transfer member 40 may be integrated with heat dissipating member 50. First heat transfer member 40 may determine the position of core 30 relative to heat dissipating member 50.

Heat dissipating member 50 may also be thermally connected to first core portion (31, 32) and second core portion (33, 34). Heat dissipating member 50 may also be in contact with first core portion (31, 32) and second core portion (33, 34).

Heat dissipating member 50 may be a part of a housing of power conversion system 1 that contains core 30, coil 25, and first heat transfer member 40. Heat dissipating member 50 may support core 30, first heat transfer member 40, and first substrate 21. Core 30 and first heat transfer member 40 may be placed on heat dissipating member 50. Heat dissipating member 50 may be grounded. Heat dissipating member 30 may be a heat sink.

Heat dissipating member 50 may be constituted of a metallic material, such as iron (Fe), aluminum (Al), an iron (Fe) alloy, or an aluminum (Al) alloy. Heat dissipating member 50 may have a thermal conductivity of 0.1 W/(m·K) or more, preferably 1.0 W/(m·K) or more, more preferably 10.0 W/(m·K) or more. Heat dissipating member 50 may be preferably constituted of a highly thermal conductive material, such as aluminum (Al) or an aluminum (Al) alloy.

Second heat transfer member 27 is arranged between coil 25 and first heat transfer member 40. Second heat transfer member 27 may be in surface contact with coil 25 and first heat transfer member 40. Second heat transfer member 27 may be in contact not only with the upper surface of coil 25 but also with a side surface of coil 25. Second heat transfer member 27 may be in contact with a plurality of surfaces of first heat transfer member 40. Second heat transfer member 27 thermally connects coil 25 to first heat transfer member 40. Second heat transfer member 27 has electric insulating properties. Second heat transfer member 27 electrically insulates first heat transfer member 40 from coil 25. If first heat transfer member 40 is constituted of an electric insulator, second heat transfer member 27 may be dispensed with.

Second heat transfer member 27 may also be arranged between coil 25 and core 30. Second heat transfer member 27 may be in surface contact with coil 25 and core 30. Second heat transfer member 27 thermally connects core 30 to coil 23. Second heat transfer member 27 may also be arranged between coil 25 and first core portion (31, 32), and between coil 25 and second core portion (33, 34). Second heat transfer member 27 may be in surface contact with coil 25, first core portion (31, 32), and second core portion (33, 34). Second heat transfer member 27 thermally connects first core portion (31, 32) and second core portion (33, 34) to coil 25. Second heat transfer member 27 may also be arranged between coil 25 and first sub-core portion 31, and between coil 25 and third sub-core portion 33. Second heat transfer member 27 may be in surface contact with coil 25, first sub-core portion 31, and third sub-core portion 33. Second heat transfer member 27 thermally connects first sub-core portion 31 and third sub-core portion 33 to coil 25.

Second beat transfer member 28 may also be arranged between first substrate 21 and core 30. Second heat transfer member 28 may be in surface contact with first substrate 21 and core 30. Second heat transfer member 28 thermally connects core 30 to first substrate 21. Second heat transfer member 23 may be arranged between first substrate 21 and first core portion (31, 32), and between first substrate 21 and second core portion (33, 34). Second heat transfer member 28 may be in surface contact with first substrate 21, first core portion (31, 32), and second core portion (33, 34). Second heat transfer member 28 thermally connects first core portion (31 , 32) and second core portion (33, 34) to first substrate 21. Second heat transfer member 28 may be arranged between coil 25 and second sub-core portion 32, and between coil 25 and fourth sub-core portion 34. Second heat transfer member 28 may be in surface contact with first substrate 21, second sub-core portion 32, and fourth sub-core portion 34. Second heat transfer member 28 thermally connects second sub-core portion 32 and fourth sub-core portion 34 to first substrate 21. Second heat transfer member 28 may be dispensed with, and first substrate 21 may be in direct surface contact with core 30.

First heat transfer member 40 may also be in contact with side surfaces of second heat transfer members 27, 28. The heat generated at coil 25 during operation of the circuit can be transferred to first heat transfer member 40 through second heat transfer members 27, 28 with a lower thermal resistance. Second heat transfer member 28 arranged between first substrate 21 and core 30 may be integrated with second heat transfer member 21 arranged between coil 25 and first heat transfer member 40, or may not be integrated with it.

Second heat transfer members 21, 28 have a higher thermal conductivity than first substrate 21. Second heat transfer members 27, 28 may have a higher thermal conductivity than core 30. Second heat transfer members 27, 28 may have a thermal conductivity of 0.1 W/(m·K) or more, preferably 1.0 W/(m·K) or more, more preferably 10.0 W/(m·K) or more. Second heat transfer members 27, 28 may have a rigidity or may have flexibility. Second heat transfer members 27, 28 may have elasticity. Second heat transfer members 27, 28 may be constituted of a rubber material, such as silicone or urethane; a resin material, such as acrylonitrile-butadiene-styrene (ABS), polybutylene terephthalate (PBT), polyphenylene sulfide (PPS), or phenols; a macromolecular material, such as polyimide; or a ceramic material, such as alumina or aluminum nitride. Second heat transfer members 27, 28 may be, for example, silicone rubber sheets.

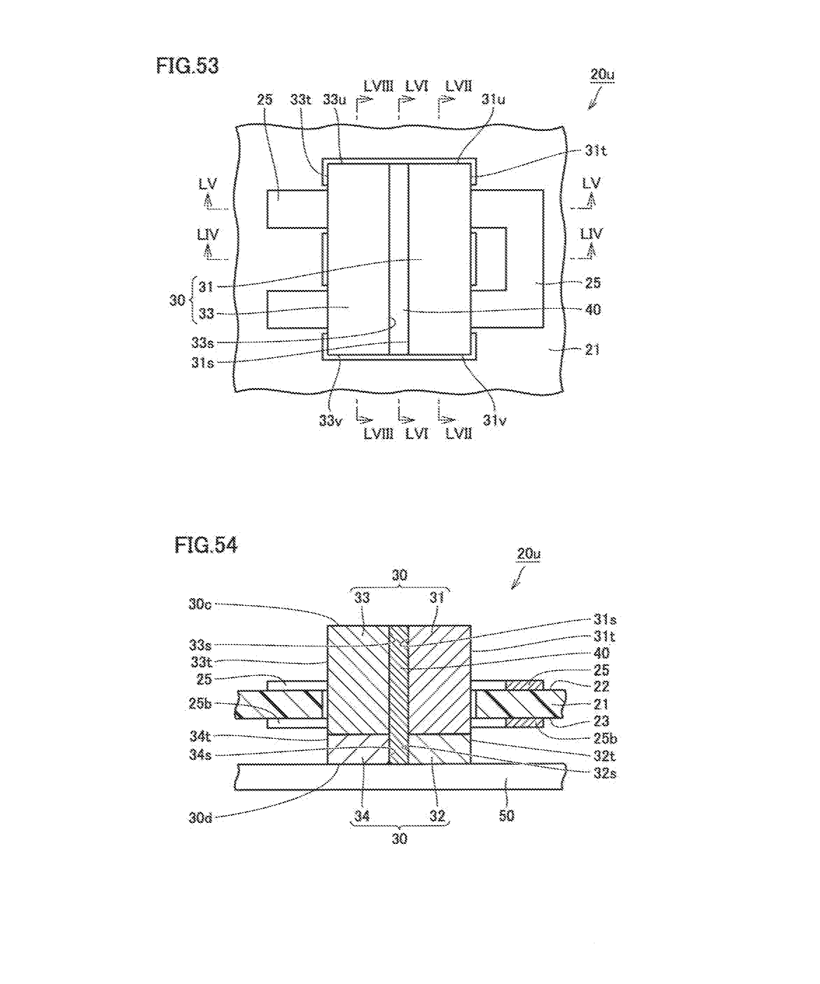

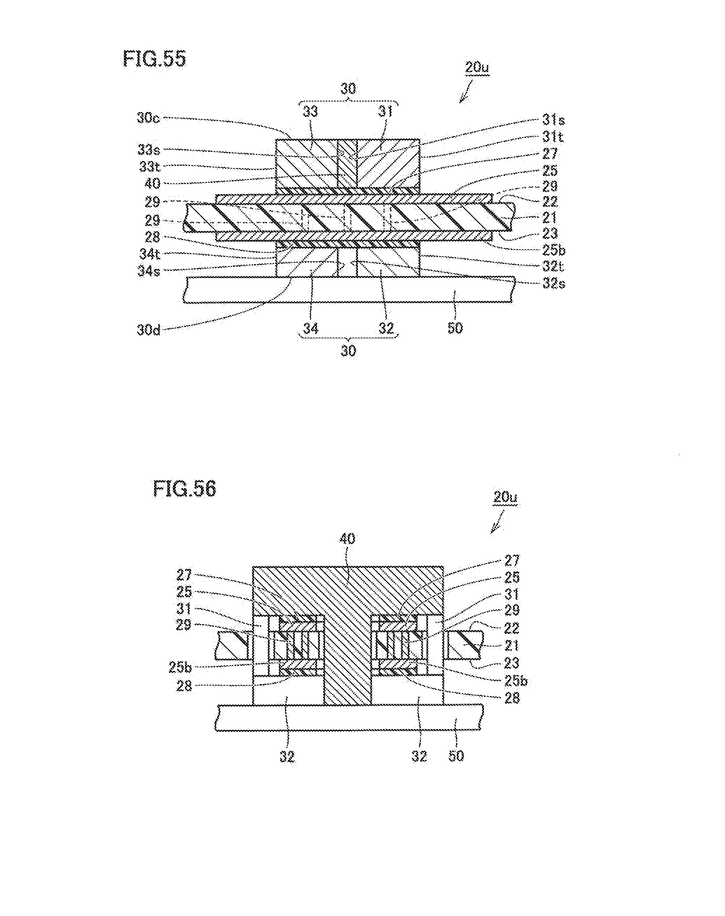

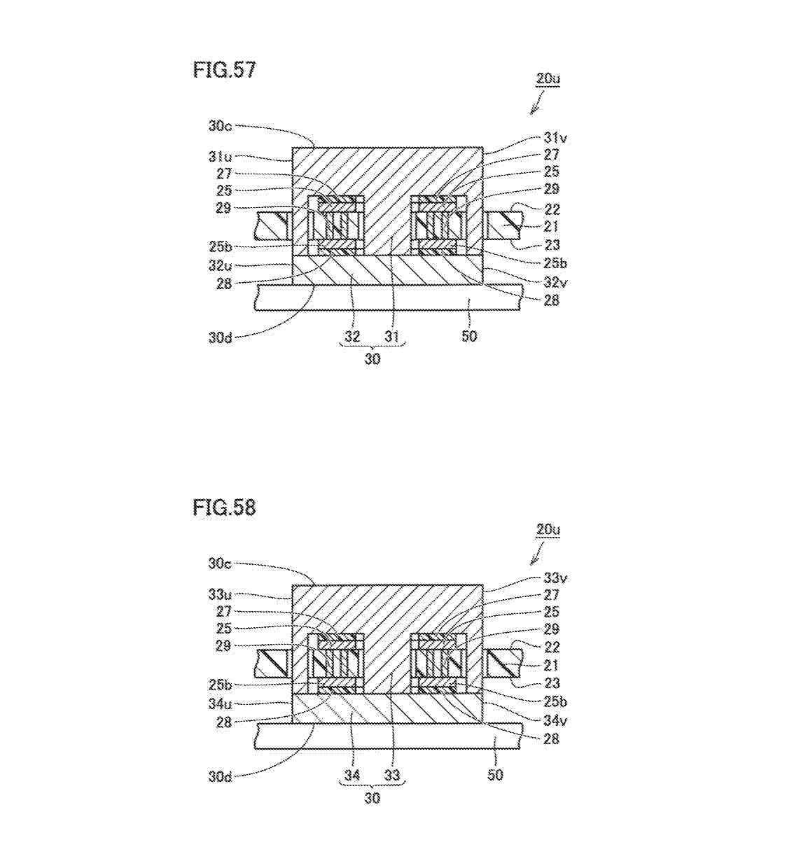

First substrate 21 may be a printed substrate. In the present embodiment, first substrate 21 is a single-sided printed wiring substrate where coil 25 is arranged on front side 22 of first substrate 21. First substrate 21 may be a double-sided printed wiring substrate that includes coil 25 on front side 22 of first substrate 21, and a second coil 25b on a back side 23 of first substrate 21 (see FIG. 53 to FIG. 58). First substrate 21 may be a multilayer substrate that includes multilayer coil 25 on front side 22 and back side 23 of first substrate 21 and inside first substrate 21. First substrate 21 may be a glass epoxy substrate, such as a FR-4 substrate. Core 30 and first heat transfer member 40 may be positioned in an opening in first substrate 21.

The advantageous effects of circuit apparatus 20 and power conversion system 1 in the present embodiment will now be described.

Circuit apparatus 20 in the present embodiment includes core 30, coil 25 surrounding at least a part of core 30, first heat transfer member 40, and beat dissipating member 50. Core 30 includes first core portion (31, 32) and second core portion (33, 34). First heat transfer member 40 is arranged between first core portion (31, 32) and second core portion (33, 34). Heat dissipating member 50 is thermally connected to first core portion (31, 32), second core portion (33, 34), and first heat transfer member 40. First heat transfer member 40 has a higher thermal conductivity than core 30. Core 30 includes lower surface 30d facing heat dissipating member 50 and upper surface 30c opposite to lower surface 30d. First core portion (31, 32) includes first side surface (31s, 32s) connecting upper surface 30c and lower surface 30d to each other and facing first heat transfer member 40. Second core portion (33, 34) includes second side surface (33s, 34s) connecting upper surface 30c and lower surface 30d to each other and feeing first heat transfer member 40. First heat transfer member 40 is in surface contact with first side surface(31s, 32s) and second side surface (33s, 34s). First heat transfer member 40 is thermally connected to coil 25.

First heat transfer member 40 is in surface contact with first side surface (31s, 32s) of first core portion (31, 32) and second side surface (33s, 34s) of second core portion (33, 34). First heat transfer member 40 can reduce the difference among a first core temperature at upper surface 30c of core 30, a second core temperature at lower surface 30d of core 30, and a third core temperature at the region between upper surface 30c and lower surface 30d of core 30. Further, the heat generated at coil 25 during operation of circuit apparatus 20 can be transferred to first heat transfer member 40. A local temperature rise of a part of core 30 facing coil 25 due to the heat generated at coil 25 during operation of circuit apparatus 20 can be suppressed. According to circuit apparatus 20 in the present embodiment, the rise in temperature of core 30 during operation of circuit apparatus 20 can be more uniformly suppressed. According to circuit apparatus 20 in the present embodiment, core 30 is prevented from locally having a high temperature, and thus the losses at core 30 such as eddy-current losses and hysteresis losses can decrease.

For example, in a comparative example with no first heat transfer member 40 and with core 30 having integrated first core portion (31, 32) and second core portion (33, 34), when coil 25 is applied with an electric current and generates heat during operation of circuit apparatus 20, the portion of coil 25 surrounded by core 30 and the central portion of core 30 feeing coil 25 locally have a high temperature. Unlike this case, in circuit apparatus 20 in the present embodiment, core 30 is divided into first core portion (31, 32) and second core portion (33, 34), and first heat transfer member 40 is arranged between first core portion (31, 32) and second core portion (33, 34) and is in surface contact with first side surface (31s, 32s) of first core portion (31, 32) and second side surface (33s, 34s) of second core portion (33, 34). Accordingly, heat can be dissipated from the central portion of core 30 facing cost 25 to heat dissipating member 50 through first heat transfer member 40. Thus, the temperature rise of coil 25 can be reduced, and a local temperature rise of core 30 can be suppressed.

In circuit apparatus 20 is the present embodiment, heat dissipating member 50 is thermally connected to first core portion (31, 32), second core portion (33, 34) and first heat transfer member 40. The heat generated at core 30 during operation of circuit apparatus 20 is dissipated from heat dissipating member 50 to the outside of circuit apparatus 20 through a first heat dissipating path from core 30 to heat dissipating member 50 via first heat transfer member 40; and a second path from core 30 directly to heat dissipating member 50. Circuit apparatus 20 in the present embodiment has an increased number of heat dissipating paths for the heat generated at core 30, and thus can suppress the rise in temperature of core 30.

Since circuit apparatus 20 in the present embodiment can suppress the rise in temperature of core 30 during operation of circuit apparatus 20, the quantity of heat dissipated from core 30 to the region around core 30 is reduced, and thus the temperature of the region around core 30 is reduced. Accordingly, the rise in temperature of the electronic components (e.g. secondary-side switching elements 13a, 13b, 13c, 13d or capacitor 14b) arranged around core 30 can be reduced.

Power conversion system 1 in the present embodiment includes circuit apparatus 20. First heat transfer member 40 is in surface contact with first side surface (31s, 32s) of first core portion (31, 32) and second side surface (33s, 34s) of second core portion (33, 34). First heat transfer member 40 can reduce the difference among a first core temperature at upper surface 30c of core 30, a second core temperature at lower surface 30d of core 30, and a third core temperature at the region between upper surface 30c and lower surface 30d of core 30. According to power conversion system 1 in the present embodiment, the rise in temperature of core 30 can be more uniformly suppressed during operation of circuit apparatus 20.

### Embodiment 2

With reference to FIG. 8, a circuit apparatus 20a according to embodiment 2 is described. Circuit apparatus 20a in the present embodiment is similar to circuit apparatus 20 in embodiment 1 in configuration but is different from the latter mainly in the following respects.

In circuit apparatus 20a in the present embodiment, a core 30a includes a third core portion (35, 36), in addition to first core portion (31, 32) and second core portion (33, 34). The number of core portions included in core 30a is not limited to three but may be four or more.

Lower surface 30d of core 30a may be constituted of the lower surface of first core portion (31, 32), the lower surface of second core portion (33, 34), and the lower surface of third core portion (35, 36). The lower surface of third core portion (35, 36) faces heat dissipating member 50. The lower surface of third core portion (35, 36) may be in contact with heat dissipating member 50. Third core portion (35, 36) is placed on heat dissipating member 50. Upper surface 30c of core 30a may be constituted of the upper surface of first core portion (31, 32), the upper surface of second core portion (33, 34), and the upper surface of third core portion (35, 36). Third core portion (35, 30) may have a rectangular parallelepiped shape or other shapes.

Fourth side surface (33t, 34t) of second core portion (33, 34) faces a first heat transfer member 41. Third core portion (35, 36) includes a side surface (35s, 36s) connecting upper surface 30c and lower surface 30d to each other and facing first heat transfer member 41. Third core portion (35, 36) includes a side surface (35t, 36t) connecting upper surface 30c and lower surface 30d to each other and being opposite to side surface (35s, 36s).

Third core portion (35, 36) may include a fifth sub-core portion 35 and a sixth sub-core portion 36. Fifth sub-core portion 35 includes side surface 35s facing first heat transfer member 41, and side surface 35t opposite to side surface 35s. Sixth sub-core portion 36 includes side surface 36s facing first heat transfer member 41, and side surface 36t opposite to side surface 36s.

Lower surface 30d of core 30a may be constituted of the lower surface of second sub-core portion 32, the lower surface of fourth sub-core portion 34, and the lower surface of sixth sub-core portion 30. The lower surface of sixth sub-core portion 36 faces heat dissipating member 50. The lower surface of sixth sub-core portion 36 may be in contact with heat dissipating member 50. Upper surface 30c of core 30a may be constituted of the upper surface of first sub-core portion 31, the upper surface of third sub-core portion 33, and the upper surface of fifth sub-core portion 35.

Third core portion (35, 36) may be an EI type core. Fifth sub-core portion 35 may have an E shape, and sixth sub-core portion 36 may have an I shape. Third core portion (35, 36) may be an EE type core, a U type core, an EER type core, or an ER type core. Core 30a may surround a part of coil 25. Fifth sub-core portion 35 and sixth sub-core portion 30 may surround a part of coil 25.

Circuit apparatus 20a in the present embodiment includes a plurality of first heat transfer members 40, 41. Circuit apparatus 20a in the present embodiment includes first heat transfer member 41 in addition to first heat transfer member 40. First heat transfer member 41 has a higher thermal conductivity than core 30a. First heat transfer member 41 may have the same thermal conductivity as first heat transfer member 40. First heat transfer member 41 may be constituted of the same material as first heat transfer member 40.

First heat transfer member 41 is arranged between second core portion (33, 34) and third core portion (35, 36). First heat transfer member 41 is thermally connected to first core portion (31, 32) and second core portion (33, 34). First heat transfer member 41 is in surface contact with fourth side surface (33t, 34t) of second core portion (33, 34) and side surface (35s, 36s) of third core portion (35, 36). First heat transfer member 41 may be in direct contact with fourth side surface (33t, 34t) of second core portion (33,34) and side surface (35s, 36s) of third core portion (33, 30), or may be in contact with them with a thermally conductive adhesive member being interposed. The heat generated at core 30a during operation of circuit apparatus 20 is transferred to heat dissipating member 50 through first heat transfer members 40, 41.

Heat dissipating member 50 is thermally connected not only to first heat transfer member 40 but also to first heat transfer member 41. The heat generated at core 30a during operation of circuit apparatus 20 can be dissipated to the outside of circuit apparatus 20 through first heat transfer members 40, 41 and heat dissipating member 50. Heat dissipating member 50 is thermally connected not only to first core portion (31, 32) and second core portion (33, 34) but also to third core portion (35, 36). First heat transfer member 41 and third core portion (35, 36) are placed on heat dissipating member 50. First heat transfer member 41 and third core portion (35, 36) may be in surface contact with heat dissipating member 50.

Circuit apparatus 20a in the present embodiment brings about the following advantageous effects, in addition to the advantageous effects of circuit apparatus 20 in embodiment 1.

In circuit apparatus 20a in the present embodiment, heat dissipating member 50 is thermally connected to first heat transfer menders 40, 41 at a plurality of portions. The area of contact between heat dissipating member 50 and first heat transfer members 40, 41 is increased. Circuit apparatus 20a in the present embodiment has an increased number of heat dissipating paths for the heat generated at core 30a, and thus can suppress the rise in temperature of core 30a.

In circuit apparatus 20a in the present embodiment, first heat transfer members 40, 41 are in surface contact not only with first side surface (31s, 32s) of first core portion (31, 32) and second side surface (33s, 34s) of second core portion (33, 34), but also with fourth side surface (33t, 34t) of second core portion (33, 34) and side surface (35s, 36s) of third core portion (35, 36). The area of contact between first heat transfer members 40, 41 and core 30a is increased. According to circuit apparatus 20a in the present embodiment, the rise in temperature of core 30a can be even more uniformly suppressed during operation of circuit apparatus 20a.

### Embodiment 3

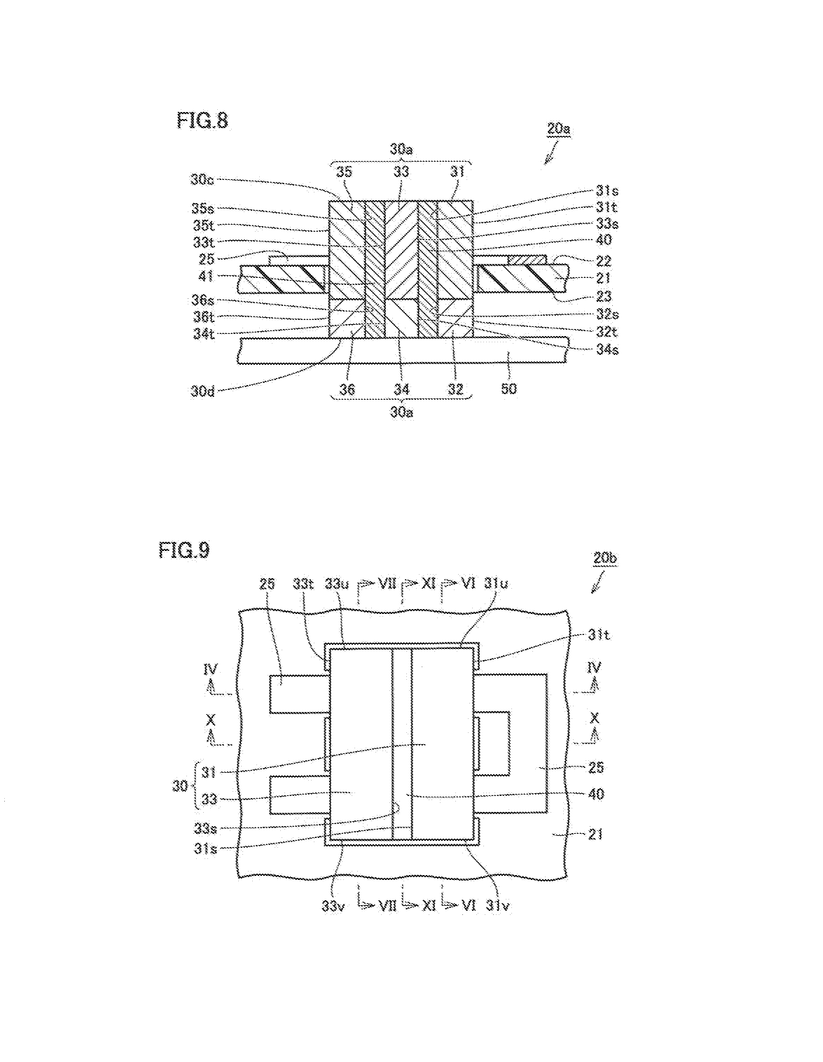

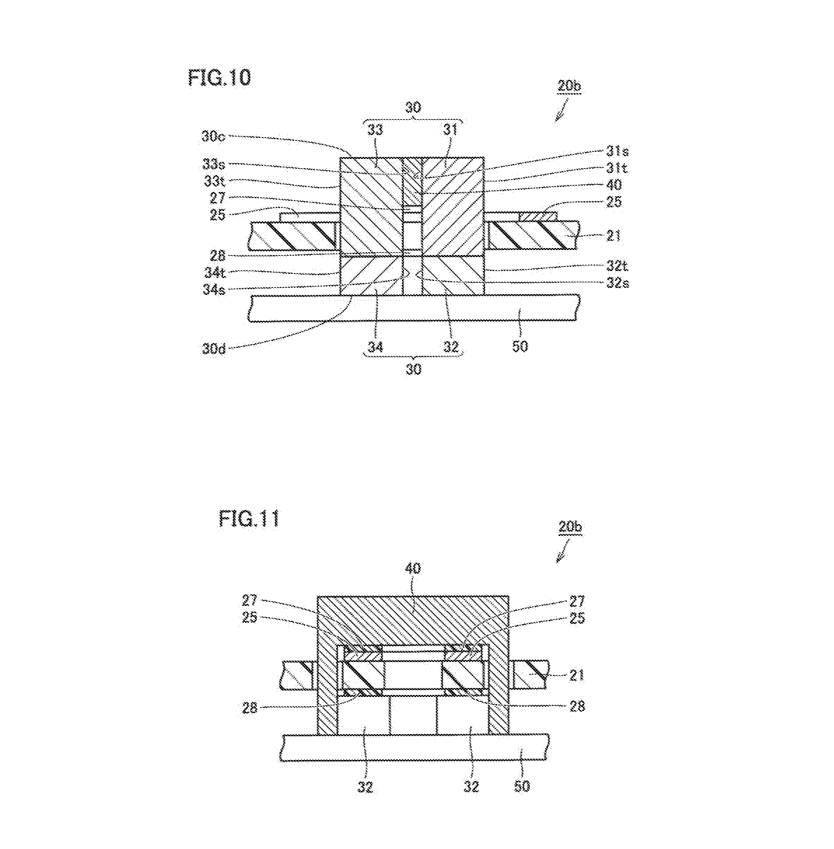

With reference to FIG. 9 to FIG. 13, circuit apparatuses 20b and 20c respectively according to embodiment 3 and its variation are described. Circuit apparatuses 20b and 20c respectively its the present embodiment and its variation are similar to circuit apparatus 20 in embodiment 1 in configuration but are different from the latter mainly in the following respects.

With reference to FIG. 9 to FIG. 11, in circuit apparatus 20b in the present embodiment, heat dissipating member 50 is thermally connected to first heat transfer member 40 at a plurality of portions. Specifically, heat dissipating member 50 is thermally connected to first heat transfer member 40 at two portions. First heat transfer member 40 may include two leg portions which are each in contact with heat dissipating member 50.

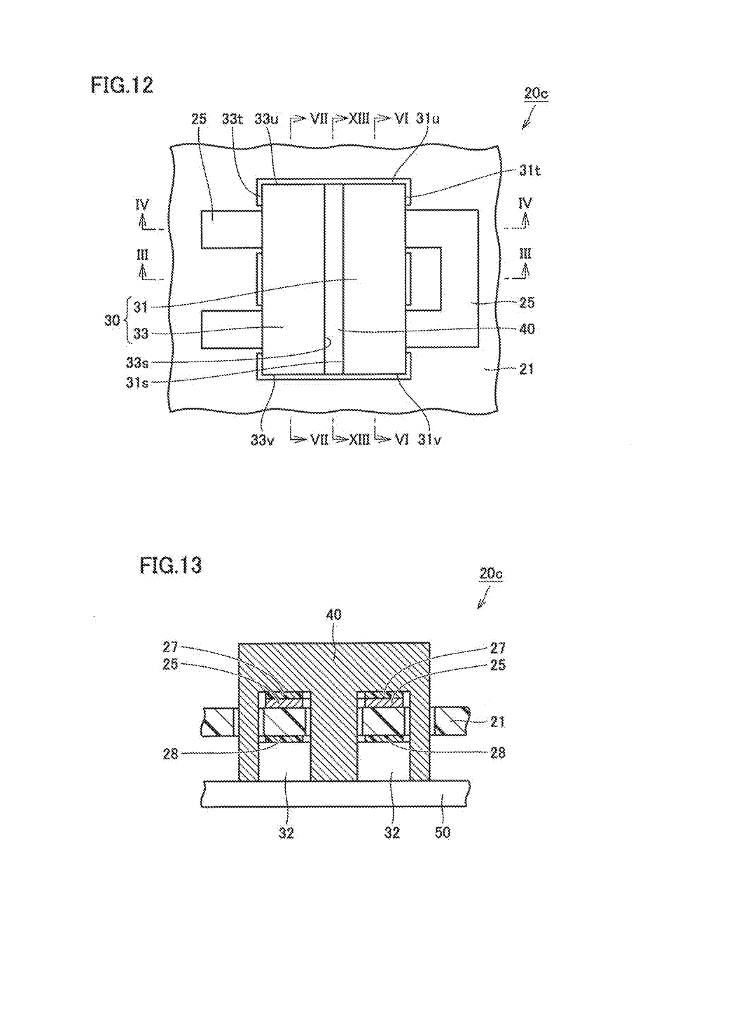

With reference to FIG. 12 and FIG. 13, in circuit apparatus 20c in a variation of the present embodiment, heat dissipating member 50 is thermally connected to first heat transfer member 48 at a plurality of portions. Specifically, heat dissipating member 50 is thermally connected to first heat transfer member 40 at three portions. First heat transfer member 40 may include three leg portions which are each in contact with heat dissipating member 50.

Circuit apparatuses 20b and 20c respectively in the present embodiment and its variation bring about the following advantageous effects, in addition to the advantageous effects of circuit apparatus 20 in embodiment 1. In circuit apparatuses 20b and 20c respectively in the present embodiment and its variation, heat dissipating member 50 is thermally connected to first heat transfer member 40 at a plurality of portions. The area of contact between heat dissipating member 50 and first heat transfer member 40 is increased. Circuit apparatuses 20b and 20c respectively in the present embodiment and its variation have an increased number of heat dissipating paths for the heat generated at core 30, and thus can suppress the rise in temperature of core 30.

### Embodiment 4

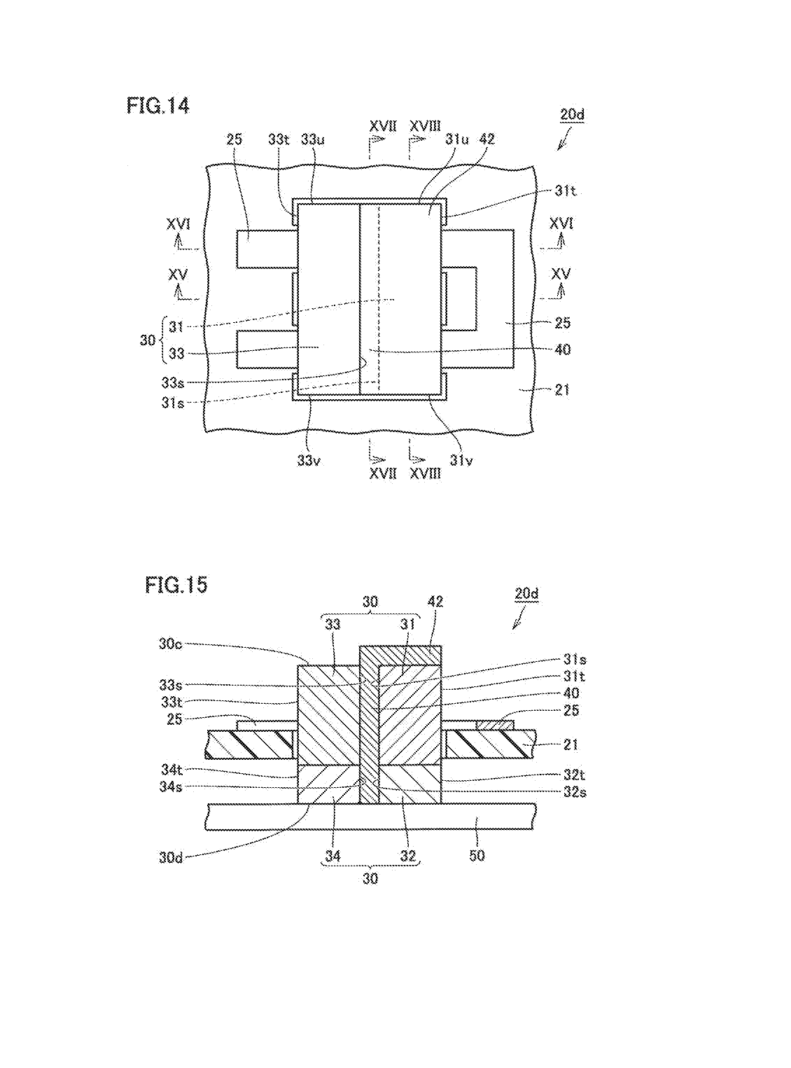

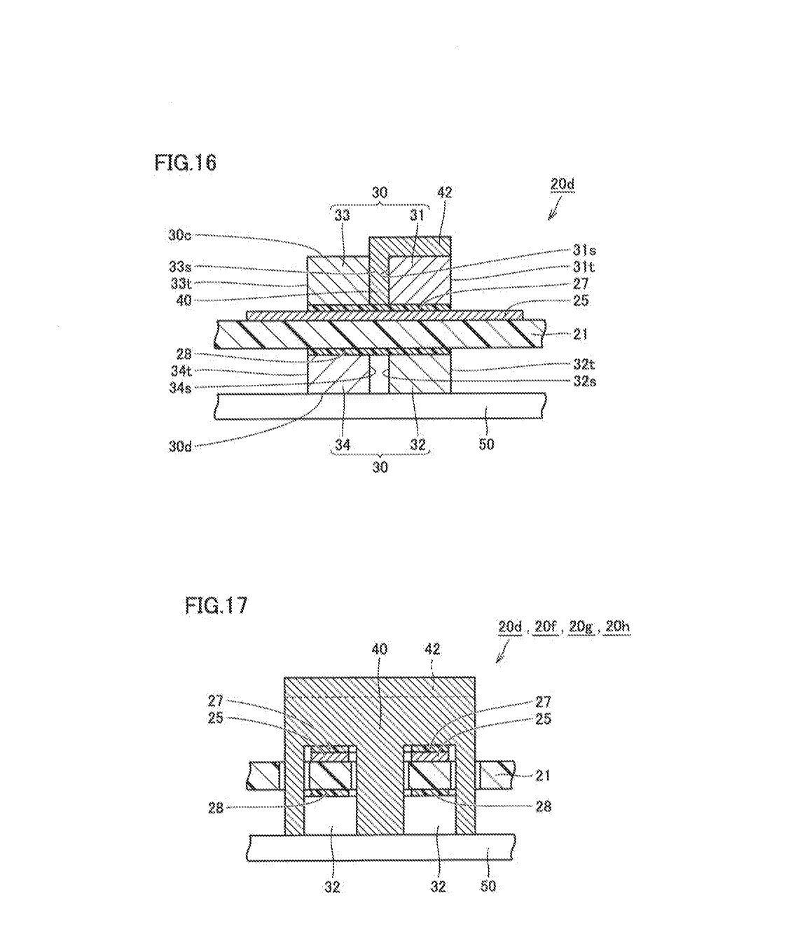

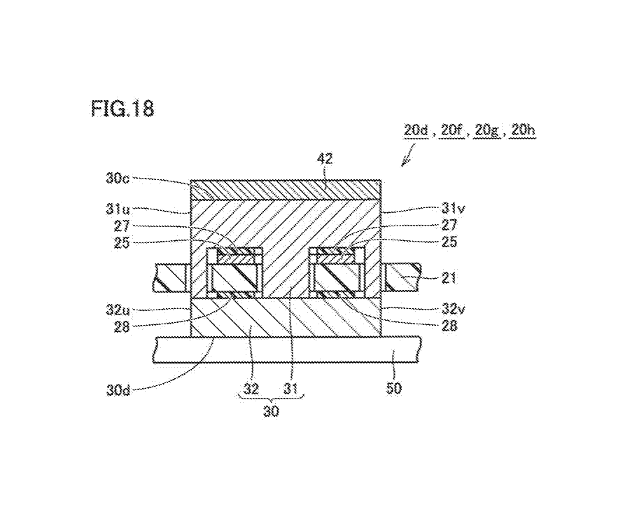

With reference to FIG. 14 to FIG. 18, a circuit apparatus 20d according to embodiment 4 is described. Circuit apparatus 20d in the present embodiment is similar to circuit apparatus 20c in a variation of embodiment 3 in configuration but is different from the latter mainly in the following respects.

In circuit apparatus 20d in the present embodiment, first heat transfer member 40 is further in surface contact with upper surface 30c. First heat transfer member 40 includes a first extension 42 which is in surface contact with upper surface 30c of core 30. First extension 42 is in surface contact with at least one of the upper surface of first core portion (31, 32) and the upper surface of second core portion (33, 34). First extension 42 may be in surface contact with the upper surface of first core portion (31, 32) in part or in whole. First extension 42 may be in surface contact with the upper surface of second core portion (33, 34) in part or in whole. First extension 42 may be in surface contact with upper surface 30c of core 30 in whole.

Circuit apparatus 20d in the present embodiment brings about the following advantageous effects, in addition to the advantageous effects of circuit apparatus 20c in a variation of embodiment 3.

In circuit apparatus 20d in the present embodiment, first heat transfer member 40 is further in surface contact with upper surface 30c. The area of contact between first heat transfer member 40 and core 30 is increased. According to circuit apparatus 20d in the present embodiment, the rise in temperature of core 30 can be even more uniformly suppressed during operation of circuit apparatus 20d.

In circuit apparatus 20d in the present embodiment, first heat transfer member 40 is further in surface contact with upper surface 30c. First heat transfer member 40 can reduce the magnetic flux that leaks from core 30 to the electronic components (e.g. secondary-side switching elements 13a, 13b, 13c, 13d or capacitor 14b). Circuit apparatus 20d in the present embodiment can prevent failures and malfunctions in the electronic components (e.g. secondary-side switching elements 13a, 13b, 13c, 13d or capacitor 14b) around circuit apparatus 20d.

### Embodiment 5

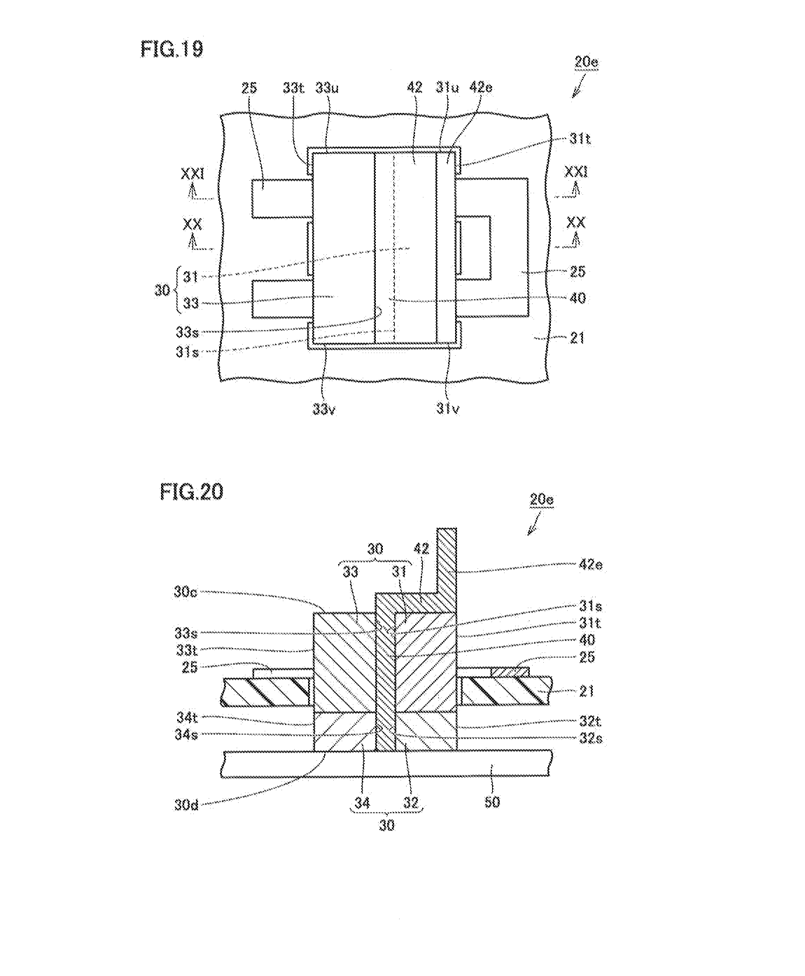

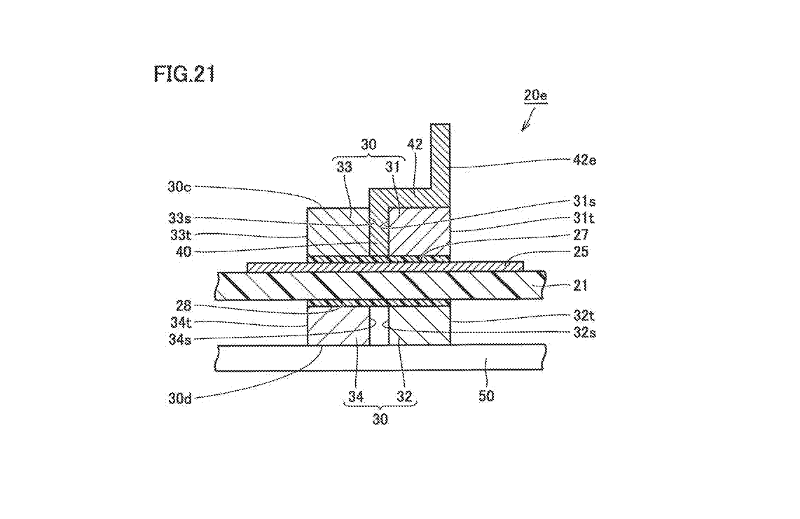

With reference to FIG. 19 to FIG. 21, a circuit apparatus 20e according to embodiment 5 is described. Circuit apparatus 20c in the present embodiment is similar to circuit apparatus 20d in embodiment 4 in configuration but is different from the latter mainly in the following respects.

In circuit apparatus 20e in the present embodiment, first heat transfer member 40 includes a first protrusion 42e protruding from upper surface 30c to the side opposite to lower surface 30d. First protrusion 40e may protrude from first extension 42 to the side opposite to lower surface 30d. First protrusion 42e may protrude from a part of first heat transfer member 40 sandwiched between first core portion (31, 32) and second core portion (33, 34) to the side opposite to lower surface 30d, with no first extension 42.

Circuit apparatus 20e in the present embodiment brings about the following advantageous effects, in addition to the advantageous effects of circuit apparatus 20d in embodiment 4. In circuit apparatus 20e in the present embodiment, first heat transfer member 40 includes first protrusion 42e protruding from upper surface 30c to the side opposite to lower surface 30d. The heat generated at core 30 during operation of circuit apparatus 20e can be dissipated to the outside of circuit apparatus 20e not only front heat dissipating member 50 but also from first protrusion 42e. According to circuit apparatus 20e in the present embodiment, the rise in temperature of core 30 during operation of circuit apparatus 20e can be more satisfactorily suppressed.

### Embodiment 6

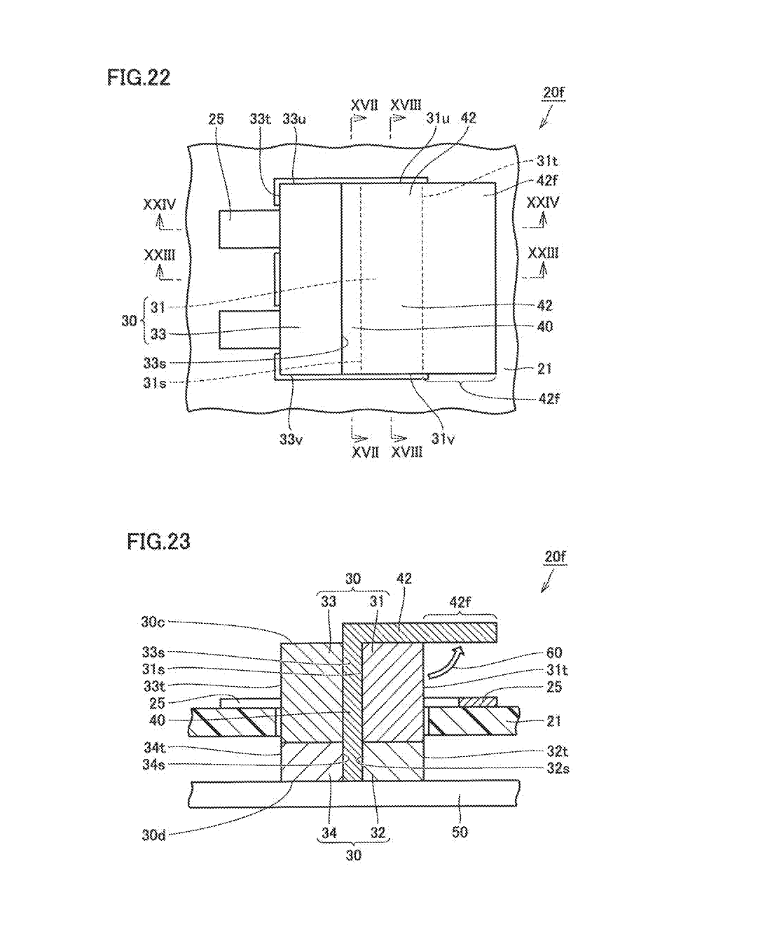

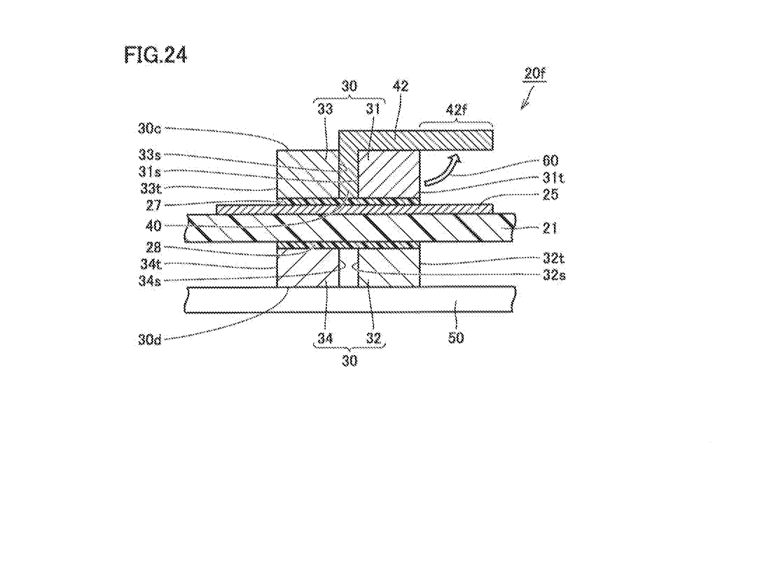

With reference to FIG. 22 to FIG. 24, a circuit apparatus 20f according to embodiment 6 is described. Circuit apparatus 20f in the present embodiment is similar to circuit apparatus 20d in embodiment 4 in configuration but is different front the latter mainly in the following respects.

In circuit apparatus 20f in the present embodiment, first heat transfer member 40 includes a second protrusion 42f protruding from upper surface 30c along upper surface 30c. Second protrusion 42f may protrude from the upper surface of first core portion (31, 32) along the upper surface of first core portion (31, 32). Second protrusion 42f may protrude from the upper surface of second core portion (33, 34) along the upper surface of second core portion (33, 34). Second protrusion 42f may protrude from the upper surface of first core portion (31, 32) along the upper surface of first core portion (31, 32) and protrude from the upper surface of second core portion (33, 34) along the upper surface of second core portion (33, 34). Second protrusion 42f extends from first extension 42.

Circuit apparatus 20f in the present embodiment brings about the following advantageous effects, in addition to the advantageous effects of circuit apparatus 20d in embodiment 4.

In circuit apparatus 20f in the present embodiment, first host transfer member 40 includes second protrusion 42f protruding from upper surface 30c along upper surface 30c. The heat generated at core 30 during operation of circuit apparatus 20f can be dissipated to the outside of circuit apparatus 20f not only from heat dissipating member 50 but also from second protrusion 42f. According to circuit apparatus 20f in the present embodiment, the rise in temperature of core 30 during operation of circuit apparatus 20f can be more satisfactorily suppressed.

In circuit apparatus 20f in the present embodiment, first heat transfer member 40 includes second protrusion 42f protruding from upper surface 30c along upper surface 30c. Second protrusion 42f can block convection of air 60 around core 30 that has been heated by the heat generated at core 30 during operation of circuit apparatus 20f. According to circuit apparatus 20f in the present embodiment, the rise in temperature of the electronic components (e.g. secondary-side switching elements 13a, 13b, 13c, 13d or capacitor 14b) arranged around core 30 can be suppressed.

### Embodiment 7

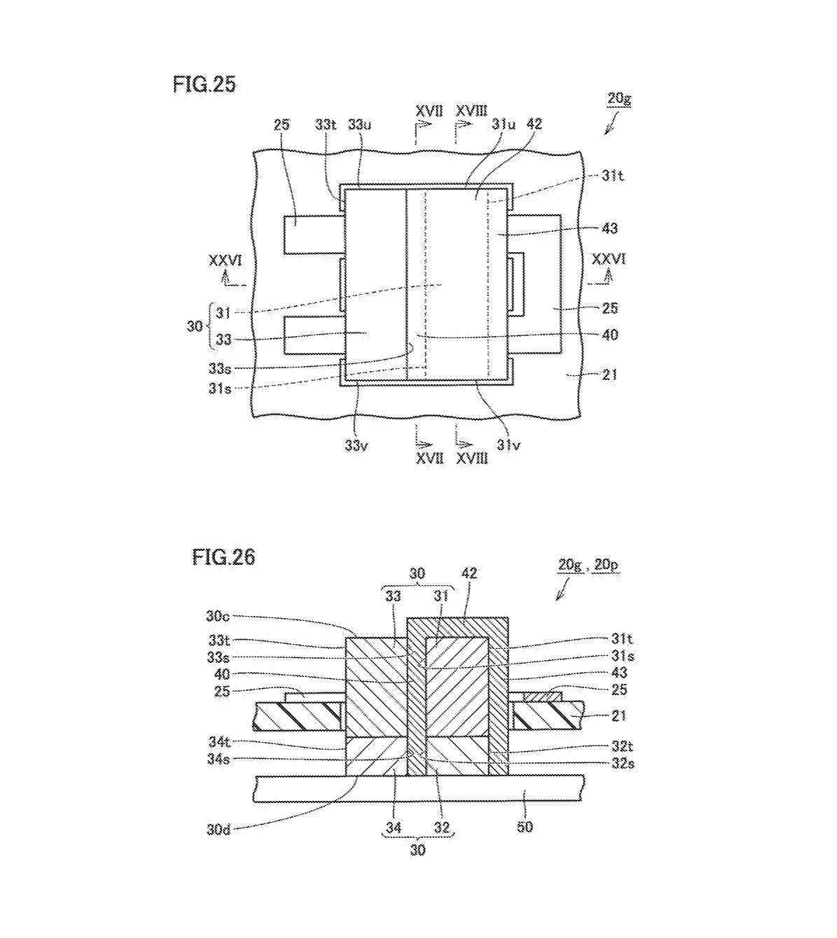

With reference to FIG. 25 and FIG. 26, a circuit apparatus 20g according to embodiment 1 is described. Circuit apparatus 20g in the present embodiment is similar to circuit apparatus 20d in embodiment 4 in configuration but is different from the latter mainly in the following respects.

In circuit apparatus 20g in the present embodiment, first core portion (31, 32) further includes third side surface (31t, 32t) connecting upper surface 30c and lower surface 30d to each other and being opposite to first side surface (31s, 32s). First heat transfer member 40 is further in surface contact with third side surface (31t, 32t). First heat transfer member 40 may be in surface contact with side surface 31t of first sub-core portion 31. First heat transfer member 40 may be in surface contact with side surface 32t of second sub-core portion 32.

First heat transfer member 40 includes a second extension 43 which is in surface contact with third side surface (31t, 32t). Second extension 43 may be in surface contact with third side surface (31t, 32t) in part or in whole. Second extension 43 may be is surface contact with side surface 31t of first sub-core portion 31. Second extension 43 may be in surface contact with side surface 32t of second sub-core portion 32.

Second extension 43 may be thermally connected to heat dissipating member 50. Second extension 43 may be in contact with heat dissipating member 50. The heat generated at core 30 is transferred to heat dissipating member 50 through second extension 43. Due to the increase in number of heat dissipating paths for the heat generated at core 30 and the decrease in length of the heat dissipating paths, the rise in temperature of core 30 can be suppressed.

Circuit apparatus 20g in the present embodiment brings about the following advantageous effects, in addition to the advantageous effects of circuit apparatus 20d in embodiment 4.

In circuit apparatus 20g in the present embodiment, first core portion (31, 32) further includes third side surface (31t, 32t) connecting upper surface 30c and lower surface 30d to each other and being opposite to first side surface (31s, 32s). First heat transfer member 40 is further in surface contact with third side surface (31t, 32t). The area of contact between first heat transfer member 40 and core 30 is increased. According to circuit apparatus 20g in the present embodiment, the rise in temperature of core 30 can be even more uniformly suppressed during operation of circuit apparatus 20g.

In circuit apparatus 20g in the present embodiment, first heat transfer member 40 is further in surface contact with third side surface (31t, 32t). First heat transfer member 40 can reduce the magnetic flux that leaks from core 30 to the electronic components (e.g. secondary-side switching elements 13a, 13b, 13c, 13d or capacitor 14b). Circuit apparatus 20g in the present embodiment can prevent failures and malfunctions in the electronic components (e.g. secondary-side switching elements 13a, 13b, 13c, 13d or capacitor 14b) around circuit apparatus 20g.

### Embodiment 8

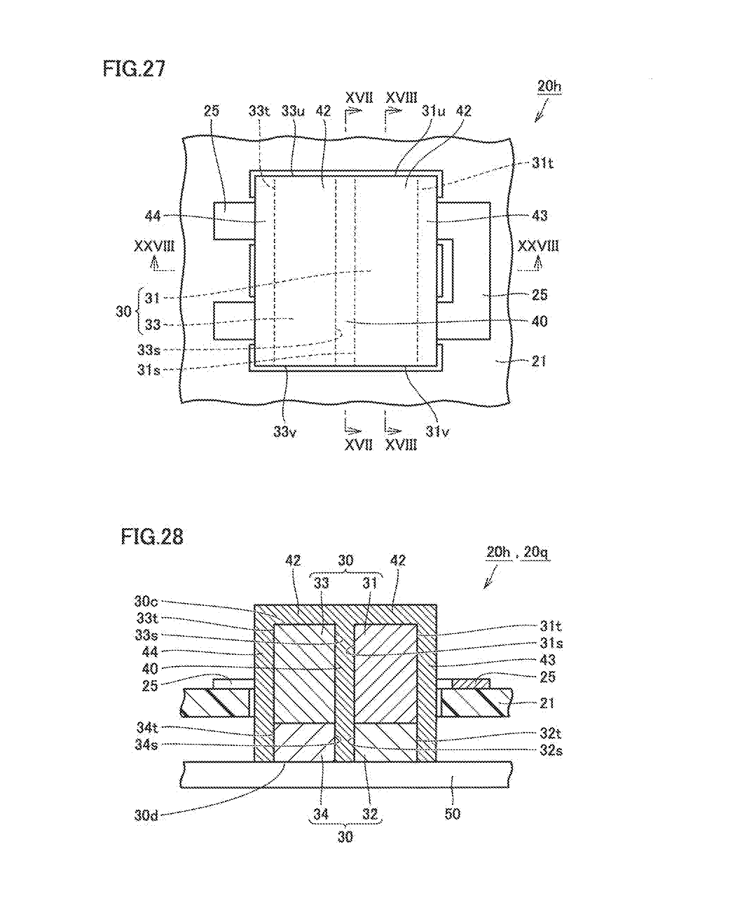

With reference to FIG. 27 and FIG. 28, a circuit apparatus 20h according to embodiment 8 is described. Circuit apparatus 20h in the present embodiment is similar to circuit apparatus 20g in embodiment 7 in configuration but is different from the latter mainly in the following respects.

In circuit apparatus 20h in the present embodiment, first heat transfer member 40 is in surface contact with the upper surface of first core portion (31, 32) and the upper surface of second core portion (33, 34). First heat transfer member 40 may be in surface contact with the upper surface of first core portion (31, 32) in part or in whole. First heat transfer member 40 may be in surface contact with the upper surface of second core portion (33, 34) in part or in whole. First heat transfer member 40 may be in surface contact with upper surface 30c of core 30 in whole.

First heat transfer member 40 includes first extension 42. First extension 42 is in surface contact with the upper surface of first core portion (31, 32) and the upper surface of second core portion (33, 34). First extension 42 may be in surface contact with the upper surface of first core portion (31, 32) in part or in whole. First extension 42 may be in surface contact with the upper surface of second core portion (33, 34) in part or in whole. First extension 42 may be in surface contact with upper surface 30c of core 30 in whole.

In circuit apparatus 20h in the present embodiment, second core portion (33, 34) further includes fourth side surface (33t, 34t) connecting upper surface 30c and lower surface 30d to each other and being opposite to second side surface (33s, 34s). First heat transfer member 40 is further in surface contact with fourth side surface (33t, 34t). First heat transfer member 40 may be in surface contact with side surface 33t of third sub-core portion 33. First heat transfer member 40 may be in surface contact with side surface 34t of fourth sub-core portion 34.

First heat transfer member 40 includes a third extension 44 which is in surface contact with fourth side surface (33t, 34t). Third extension 44 may be in surface contact with fourth side surface (33t, 34t) in part or in whole. Third extension 44 may be in surface contact with side surface 33t of third sub-core portion 33. Third extension 44 may be in surface contact with side surface 34t of fourth sub-core portion 34.

Third extension 44 may be thermally connected to heat dissipating member 50. Third extension 44 may be in contact with heat dissipating member 50. The heat generated at core 30 is transferred to heat dissipating member 50 through third extension 44. Due to the increase in number of heat dissipating paths for the heat generated at core 30 and the decrease in length of the heat dissipating paths, the rise in temperature of core 30 can be suppressed.

Circuit apparatus 20b in the present embodiment brings about the following advantageous effects, in addition to the advantageous effects of circuit apparatus 20g in embodiment 7.

In circuit apparatus 20h in the present embodiment, second core portion (33, 34) further includes fourth side surface (33t, 34t) connecting upper surface 30c and lower surface 30d to each other and being opposite to second side surface (33s, 34s). First heat transfer member 40 is further in surface contact with fourth side surface (33t, 34t). The area of contact between first heat transfer member 40 and core 30 is increased. According to circuit apparatus 20h in the present embodiment, the rise in temperature of core 30 can be even more uniformly suppressed during operation of circuit apparatus 20h.

In circuit apparatus 20h in the present embodiment, first heat transfer member 40 is further in surface contact with fourth side surface (33t, 34t). First heat transfer member 40 can reduce the magnetic flux that leaks from core 30 to the electronic components (e.g. secondary-side switching elements 13a, 13b, 13c, 13d or capacitor 14b). Circuit apparatus 20h in the present embodiment can prevent failures and malfunctions in the electronic components (e.g. secondary-side switching elements 13a, 13b, 13c, 13d or capacitor 14b) around circuit apparatus 20h.

### Embodiment 9

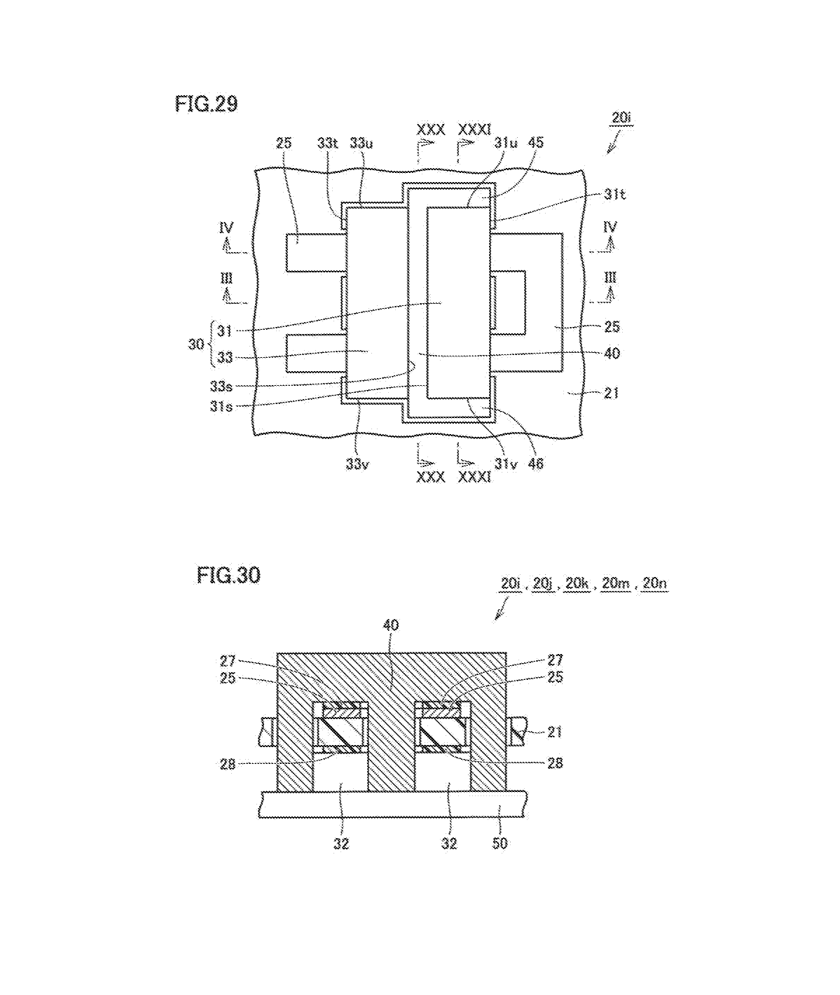

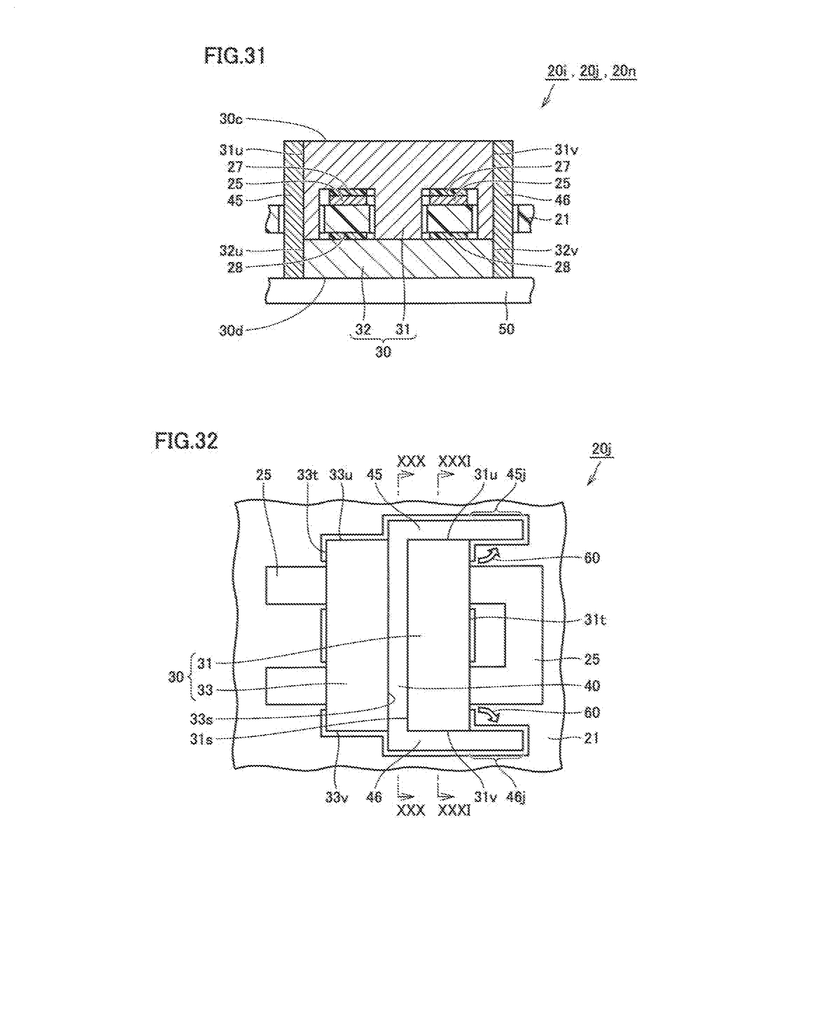

With reference to FIG. 29 to FIG. 31, a circuit apparatus 20i according to embodiment 9 is described. Circuit apparatus 20i in the present embodiment is similar to circuit apparatus 20c in a variation of embodiment 3 in configuration but is different from the latter mainly in the following respects.

In circuit apparatus 20i in the present embodiment, first core portion (31, 32) further includes: third side surface (31t, 32t) connecting upper surface 30c and lower surface 30d to each other and being opposite to first side surface (31s, 32s); fifth side surface (31u, 32u) connecting first side surface (31s, 32s) and third side surface (31t, 32t) to each other; and sixth side surface (31v, 32v) connecting first side surface (31s, 32s) and third side surface (31t, 32t) to each other and being opposite to fifth side surface (31u, 32u).

First heat transfer member 40 is further in surface contact with at least one of fifth side surface (31u, 32u) and sixth side surface (31v, 32v). First heat transfer member 40 may be in surface contact with fifth side surface (31u, 32u) in part or in whole. First heat transfer member 40 may be in surface contact with sixth side surface (31v, 32v) in part or in whole.

First heat transfer member 40 includes a fourth extension 45. Fourth extension 45 is in surface contact with fifth side surface (31u, 32u). Fourth extension 45 may be in surface contact with fifth side surface (31u, 32u) in part or in whole. First heat transfer member 40 includes a fifth extension 46. Fifth extension 46 is in surface contact with sixth side surface (31v, 32v). Fifth extension 46 may be in surface contact with sixth side surface (31v, 32v) in part or in whole. First heat transfer member 40 includes at least one of fourth extension 45 and fifth extension 46.

Fourth extension 45 may be thermally connected to heat dissipating member 50. Fourth extension 45 may be in contact with heat dissipating member 50. The heat generated at core 30 is transferred to heat dissipating member 50 through fourth extension 45. Fifth extension 46 may be thermally connected to heat dissipating member 50. Fifth extension 46 may be in contact with heat dissipating member 50. The heat generated at core 30 is transferred to heat dissipating member 50 through fifth extension 46. Due to the increase in number of heat dissipating paths for the heat generated at core 30 and the decrease in length of the heat dissipating paths, the rise in temperature of core 30 can be suppressed.

Circuit apparatus 20i in the present embodiment brings about the following advantageous effects, in addition to the advantageous effects of circuit apparatus 20c in a variation of embodiment 3.

In circuit apparatus 20i in the present embodiment, first core portion (31, 32) further includes: third side surface (31t, 32t) connecting upper surface 30c and lower surface 30d to each other and being opposite to first side surface (31s, 32s); fifth side surface (31u, 32u) connecting first side surface (31s, 32s) and third side surface (31t, 32t) to each other; and sixth side surface (31v, 32v) connecting first side surface (31s, 32s) and third side surface (31t, 32t) in each other and being opposite to fifth side surface (31u, 32u). First heat transfer member 40 is further in surface contact with at least one of fifth side surface (31u, 32u) and sixth side surface (31v, 32v). The area of contact between first heat transfer member 40 and core 30 is increased. According to circuit apparatus 20i in the present embodiment, the rise in temperature of core 30 can be even more uniformly suppressed during operation of circuit apparatus 20i.

In circuit apparatus 20i in the present embodiment, first heat transfer member 40 is further in surface contact with at least one of fifth side surface (31u, 32u) and sixth side surface (31v, 32v). First heat transfer member 40 can reduce the magnetic flux that leaks from core 30 to the electronic components (e.g. secondary-side switching elements 13a, 13b, 13c, 13d or capacitor 14b). Circuit apparatus 20i in the present embodiment can prevent failures and malfunctions in the electronic components (e.g. secondary-side switching elements 13a, 13b, 13c, 13d or capacitor 14b) around circuit apparatus 20i.

### Embodiment 10

With reference to FIG. 32, a circuit apparatus 20j according to embodiment 10 is described. Circuit apparatus 20j in the present embodiment is similar to circuit apparatus 20i in embodiment 9 in configuration but is different from the latter mainly in the following respects.

In circuit apparatus 20j in the present embodiment, first heat transfer member 40 includes third protrusions 45j, 46j. Third protrusion 45j protrudes from fifth side surface (31u, 32u) along fifth side surface (31u, 32u). Third protrusion 45j extends from fourth extension 45. Third protrusion 46j protrudes from sixth side surface (31v, 32v) along sixth side surface (31v, 32v). Third protrusion 46j extends from fifth extension 46. First heat transfer member 40 includes at least one of third protrusion 45j and third protrusion 46j.

Third protrusions 45j, 46j may be thermally connected to heat dissipating member 50. Third protrusions 45j, 46j may be in contact with heat dissipating member 50. The heat generated at core 30 is transferred to heat dissipating member 50 through third protrusions 45j, 46j. Due to the increase in number of heat dissipating paths for the heat generated at core 30 and the decrease in length of the heat-dissipating paths, the rise in temperature of core 30 can be suppressed.

Circuit apparatus 20j in the present embodiment brings about the following advantageous effects, in addition to the advantageous effects of circuit apparatus 20i in embodiment 9.

In circuit apparatus 20j in the present embodiment, first heat transfer member 40 includes third protrusion(s) 45j, 46j protruding from at least one of fifth side surface (31u, 32u) and sixth side surface (31v, 32v) along at least one of fifth side surface (31u, 32u) and sixth side surface (31v, 32v). The heat generated at core 30 during operation of circuit apparatus 20j can be dissipated to the outside of circuit apparatus 20j not only from heat dissipating member 50 but also from third protrusion(s) 45j, 46j. According to circuit apparatus 20j in the present embodiment, the rise in temperature of core 30 can be more satisfactorily suppressed during operation of circuit apparatus 20j.

In circuit apparatus 20j in the present embodiment, first heat transfer member 40 includes third protrusion(s) 45j, 46j protruding from at least one of fifth side surface (31u, 32u) and sixth side surface (31v, 32v) along at least one of fifth side surface (31u, 32u) and sixth side surface (31v, 32v). Third protrusion(s) 45j, 46j can block convection of around core 30 that has been heated by the heat generated at core 30 during operation of circuit apparatus 20f. According to circuit apparatus 20j in the present embodiment, the rise in temperature of the electronic components (e.g. secondary-side switching elements 13a, 13b, 13c, 13d or capacitor 14b) arranged around core 30 can be suppressed.

### Embodiment 11

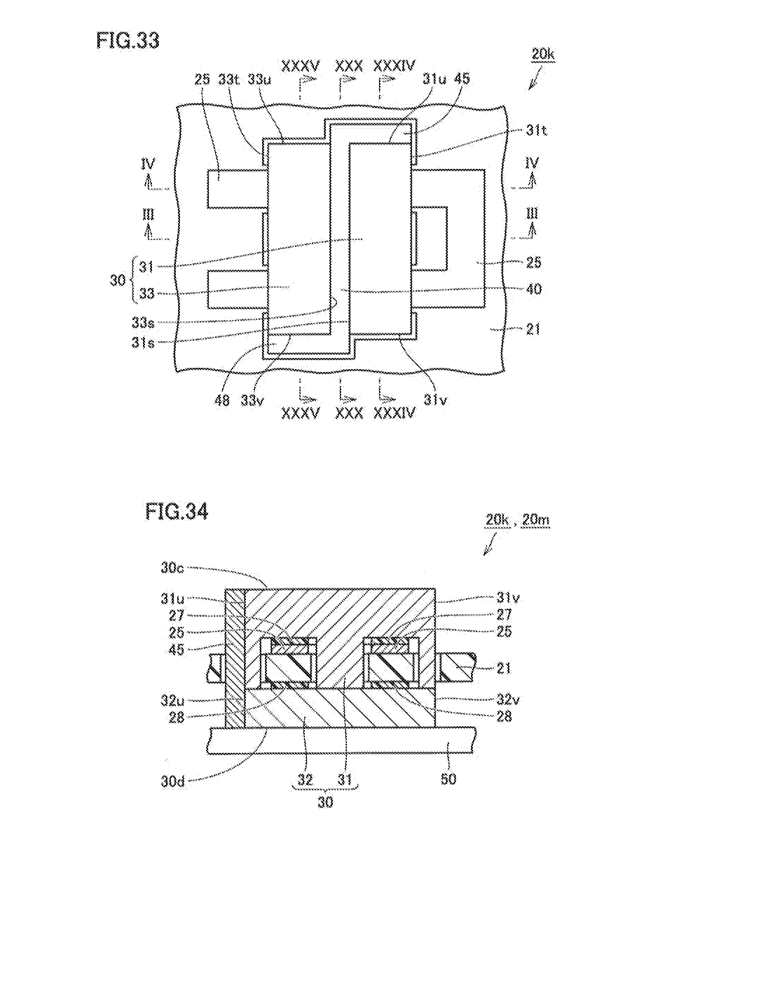

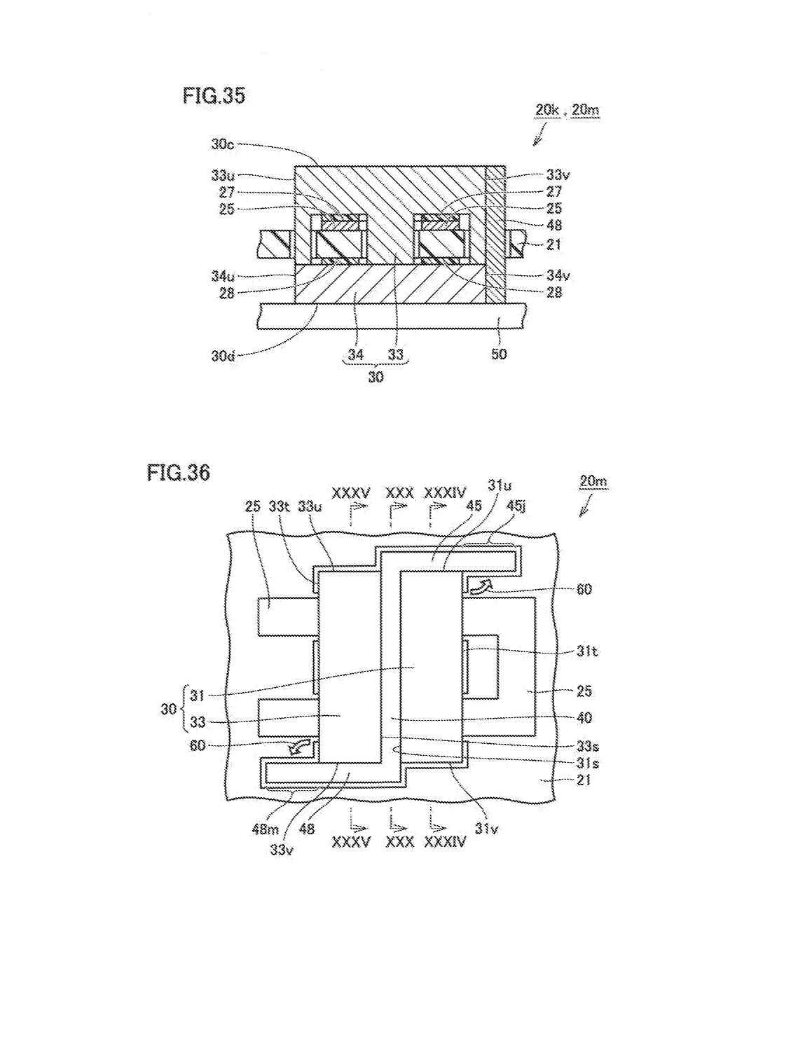

With reference to FIG. 33 to FIG. 35, a circuit apparatus 20k according to embodiment 11 is described. Circuit apparatus 20k in the present embodiment is similar to circuit apparatus 20c in a variation of embodiment 3 in configuration but is different from the latter mainly in the following respects.

In circuit apparatus 20k in the present embodiment, first core portion (31, 32) further includes: third side surface (31t, 32t) connecting upper surface 30c and lower surface 30d to each other and being opposite to first side surface (31s, 32s); fifth side surface (31u, 32u) connecting first side surface (31s, 32s) and third side surface (31t, 32t) to each other, and sixth side surface (31v, 32v) connecting first side surface (31s, 32s) and third side surface (31t, 32t) to each other and being opposite to fifth side surface (31u, 32u). Second core portion (33, 34) further includes: fourth side surface (33t, 34t) connecting upper surface 30c and lower surface 30d to each other and being opposite to second side surface (33s, 34s); seventh side surface (33u, 34u) connecting second side surface (33s, 34s) and fourth side surface (33t, 34t) to each other; and eighth side surface (33v, 34v) connecting second side surface (33s, 34s) and fourth side surface (33t, 34t) to each other and being opposite to seventh side surface (33u, 34u). Seventh side surface (33u, 34u) is adjacent to fifth side surface (31u, 32u). Eighth side surface (33v, 34v) is adjacent to sixth side surface (31v, 32v).

First heat transfer member 40 is further in surface contact with fifth side surface (31u, 32u) and eighth side surface (33v, 34v). First heat transfer member 40 includes fourth extension 45 and a seventh extension 48. Fourth extension 45 is in surface contact with fifth side surface (31u, 32u). Fourth extension 45 may be in surface contact with fifth side surface (31u, 32u) in part or in whole. Seventh extension 48 is in surface contact with eighth side surface (33v, 34v). Seventh extension 48 may be in surface contact with eighth side surface (33v, 34v) in part or whole.

Fourth extension 45 may be thermally connected to heat dissipating member 50. Fourth extension 45 may be in contact with heat dissipating member 50. the heat generated at core 30 is transferred to heat dissipating member 30 through fourth extension 45. Seventh extension 48 may be in contact with heat dissipating member 50. The heat generated at core 30 is transferred to heat dissipating member 50 through seventh extension 48. Due to the increase in number of heat dissipating paths for the heat generated at core 30 and the decrease in length of the heat dissipating paths, the rise in temperature of core 30 can be suppressed.

Circuit apparatus 20k in the present embodiment brings about the following advantageous effects, in addition to the advantageous effects of circuit apparatus 20c in a variation of embodiment 3.

In circuit apparatus 20k in the present embodiment, seventh side surface (33u, 34u) is adjacent to fifth side surface (31u, 32u). Eighth side surface (33v, 34v) is adjacent to sixth side surface (31v, 32v). First heat transfer member 40 is further in surface contact with fifth side surface (31u, 32u) and eighth side surface (33v, 34v). The area of contact between first heat transfer member 40 and core 30 is increased. First heat transfer member 40 is symmetrically arranged with respect to core 30. According to circuit apparatus 20k in the present embodiment, the rise in temperature of core 30 can be even more uniformly suppressed during operation of circuit apparatus 20k.

In circuit apparatus 20k in the present embodiment first heat transfer member 40 is in surface contact with fifth side surface (31u, 32u) of first core portion (31, 32) and eighth side surface (33v, 34v) of second core portion (33, 34). First heat transfer member 40 can reduce the magnetic flux that leaks from core 30 to the electronic components (e.g. secondary-side switching elements 13a, 13b, 13c, 13d or capacitor 14b). Circuit apparatus 20k in the present embodiment can prevent failures and malfunctions in the electronic components (e.g. secondary-side switching elements 13a, 13b, 13c, 13d or capacitor 14b) around circuit apparatus 20k.

### Embodiment 12

With reference to FIG. 36, a circuit apparatus 20m according to embodiment 12 is described. Circuit apparatus 20m in the present embodiment is similar to circuit apparatus 20k in embodiment 11 in configuration but is different from the latter mainly in the following respects.

In circuit apparatus 20m in the present embodiment, first heat transfer member 40 includes at least one of third protrusion 45j and fourth protrusion 48m. Fourth protrusion 48m protrudes from eighth side-surface (33v, 34v) along eighth side surface (33v, 34v). Fourth protrusion 48m extends from seventh extension 48.

At least one of third protrusion 45j and fourth protrusion 48m may be thermally connected to heat dissipating member 50. At least one of third protrusion 45j and fourth protrusion 48m may be in contact with heat dissipating member 50. The heat generated at core 30 is transferred to heat dissipating member 50 through at least one of third protrusion 45j and fourth protrusion 48m. Due to the increase in number of heat dissipating paths for the heat generated at core 30 and the decrease in length of the heat dissipating paths, the rise in temperature of core 30 can be suppressed.

Circuit apparatus 20m in the present embodiment brings about the following advantageous effects, in addition to the advantageous effects of circuit apparatus 20k in embodiment 11.

In circuit apparatus 20m in the present embodiment, first heat transfer member 40 includes at least one of third protrusion 45j and fourth protrusion 48m. Third protrusion 45j protrudes from fifth side surface (31u, 32u) along fifth side surface (31u, 32u). Fourth protrusion 48m protrudes from eighth side surface (33v, 34v) along eighth side surface (33v, 34v). The heat generated at core 30 during operation of circuit apparatus 20m can be dissipated to the outside of circuit apparatus 20m not only from heat dissipating member 50 but also from at least one of third protrusion 45j and fourth protrusion 48m. According to circuit apparatus 20m in the present embodiment the rise in temperature of core 30 can be more satisfactorily suppressed during operation of circuit apparatus 20m.

In circuit apparatus 20m in the present embodiment, first heat transfer member 40 includes at least one of third protrusion 45j and fourth protrusion 48m. Third protrusion 45j protrudes from fifth side surface (31u, 32u) along fifth side surface (31u, 32u). Fourth protrusion 48m protrudes from eighth side surface (33v, 34v) along eighth side surface (33v, 34v). Third protrusion 45j can block convection of air 60 around core 30 that has been heated by the heat generated at core 30 during operation of circuit apparatus 20m. According to circuit apparatus 20m in the present embodiment, the rise in temperature of the electronic components (e.g. secondary-side switching elements 13a, 13b, 13c, 13d or capacitor 14b) arranged around core 30 can be suppressed.

### Embodiment 13

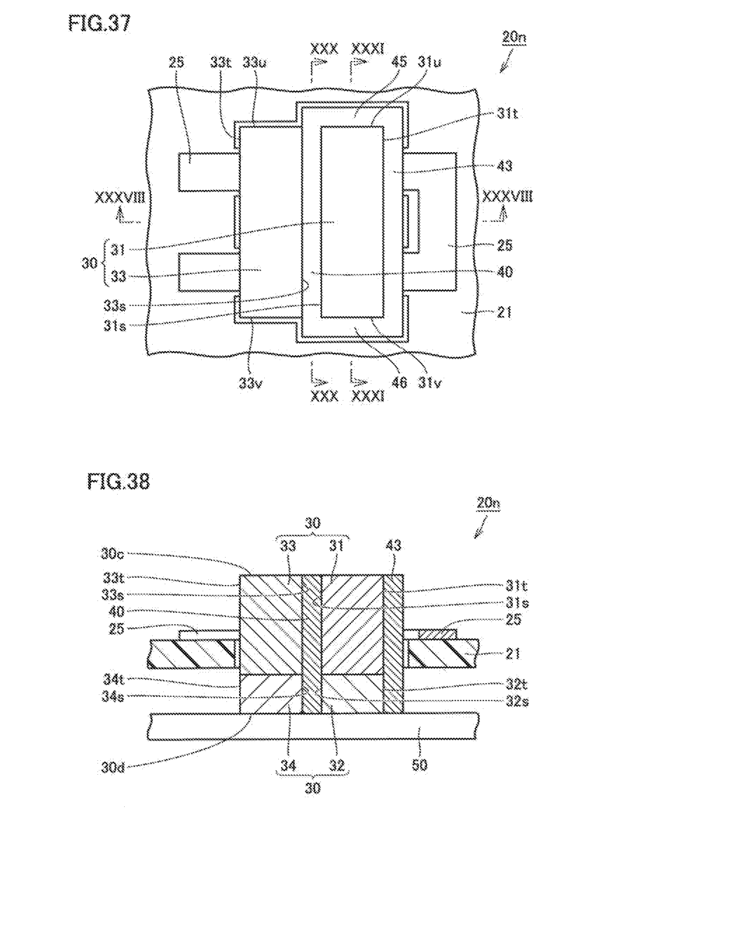

With reference to FIG. 37 and FIG. 38, a circuit apparatus 20n according to embodiment 13 is described. Circuit apparatus 20n in the present embodiment is similar to circuit apparatus 20i in embodiment 9 in configuration but is different from the latter mainly in the following respects.

In circuit apparatus 20n in the present embodiment, first heat transfer member 40 is further in surface contact with third side surface (31t, 32t). First heat transfer member 40 includes second extension 43 which is in surface contact with third side surface (31t, 32t). Second extension 43 may be in surface contact with third side surface (31t, 32t) in part or in whole. First heat transfer member 40 may be in surface contact with all the side surfaces of first core portion (31, 32).

Second extension 43 may be thermally connected to heat dissipating member 50. Second extension 43 may be in contact with heat dissipating member 50. The heat generated at core 30 is transferred to heat dissipating member 50 through second extension 43. Due to the increase in number of heat dissipating paths for the heat generated at core 30 and the decrease in length of the heat dissipating paths, the rise in temperature of core 30 can be suppressed.

Circuit apparatus 20n in the present embodiment brings about the following advantageous effects, in addition to the advantageous effects of circuit apparatus 20i in embodiment 9.

In circuit apparatus 20n in the present embodiment, first heat transfer member 40 is further in surface contact with third side surface (31t, 32t). The area of contact between first heat transfer member 40 and core 30 is increased. According to circuit apparatus 20n in the present embodiment, the rise in temperance of core 30 can be even more uniformly suppressed during operation of circuit apparatus 20n.

In circuit apparatus 20n in the present embodiment, first heat transfer member 40 is further in surface contact with third side surface (31t, 32t). First heat transfer member 40 can reduce the magnetic flux that leaks from core 30 to the electronic components (e.g. secondary-side switching elements 13a, 13b, 13c, 13d or capacitor 14b). Circuit apparatus 20n in the present embodiment can prevent failures and malfunctions in the electronic components (e.g. secondary-side switching elements 13a, 13b, 13c, 13d or capacitor 14b) around circuit apparatus 20n.

### Embodiment 14

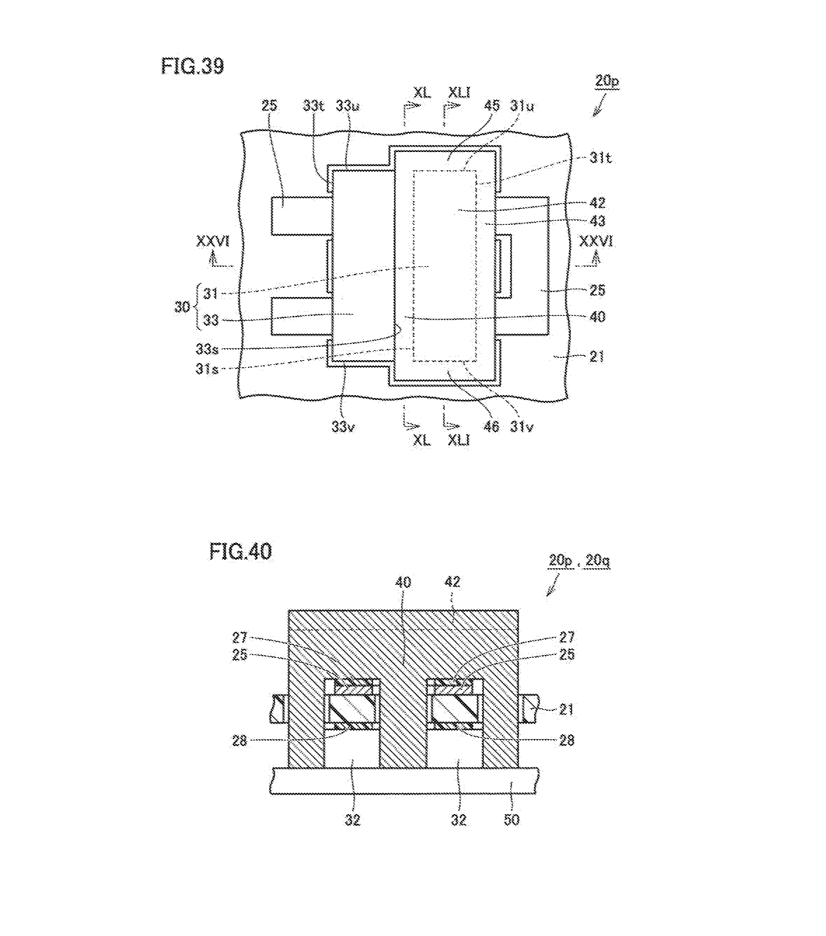

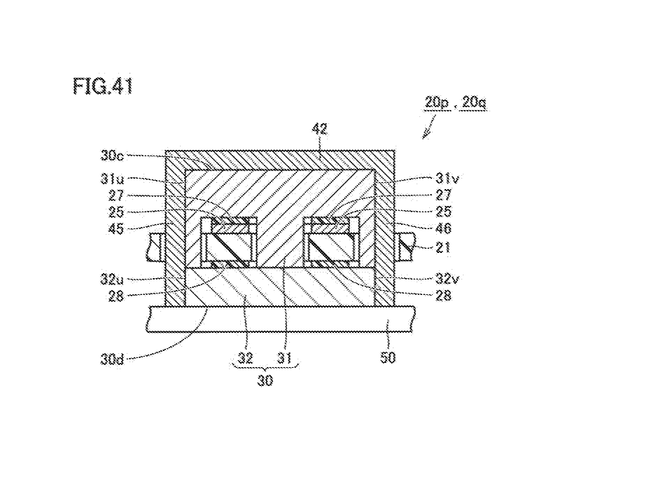

With reference to FIG. 39 to FIG. 41, a circuit apparatus 20p according to embodiment 14 is described. Circuit apparatus 20p in the present embodiment is similar to circuit apparatus 20n in embodiment 13 in configuration but is different from the latter mainly in the following respects.

In circuit apparatus 20p in the present embodiment, first heat transfer member 40 is further in surface contact with upper surface 30c of core 30. first heat transfer member 40 further includes first extension 42 which is in surface contact with upper surface 30c of core 30. First extension 42 is in surface contact with the upper surface of first core portion (31, 32). First extension 42 may be in surface contact with the upper surface of first core portion (31, 32) in part or in whole. First heat transfer member 40 may be in surface contact with all the surfaces of first core portion (31, 33) except for lower surface 30d of first core portion (31, 32). First extension 42 may also be in surface contact with the upper surface of second core portion (33, 34).

Circuit apparatus 20p in the present embodiment brings about the following advantageous effects, in addition to the advantageous effects of circuit apparatus 20n in embodiment 13.

In circuit apparatus 20p in the present embodiment, first heat transfer member 40 is further in surface contact with upper surface 30c of core 30. The area of contact between first heat transfer member 40 and core 30 is increased. According to circuit apparatus 20p in the present embodiment, the rise in temperature of core 30 can be even more uniformly suppressed during operation of circuit apparatus 20p.

In circuit apparatus 20p in the present embodiment, first heat transfer member 40 is further in surface contact with upper surface 30c of core 30. First heat transfer member 40 can reduce the magnetic flux that leaks from core 30 to the electronic components (e.g. secondary-side switching elements 13a, 13b, 13c, 13d or capacitor 14b). Circuit apparatus 20p in the present embodiment can prevent failures and malfunctions in the electronic components (e.g. secondary-side switching elements 13a, 13b, 13c, 13d or capacitor 14b) around circuit apparatus 20p.

### Embodiment 15

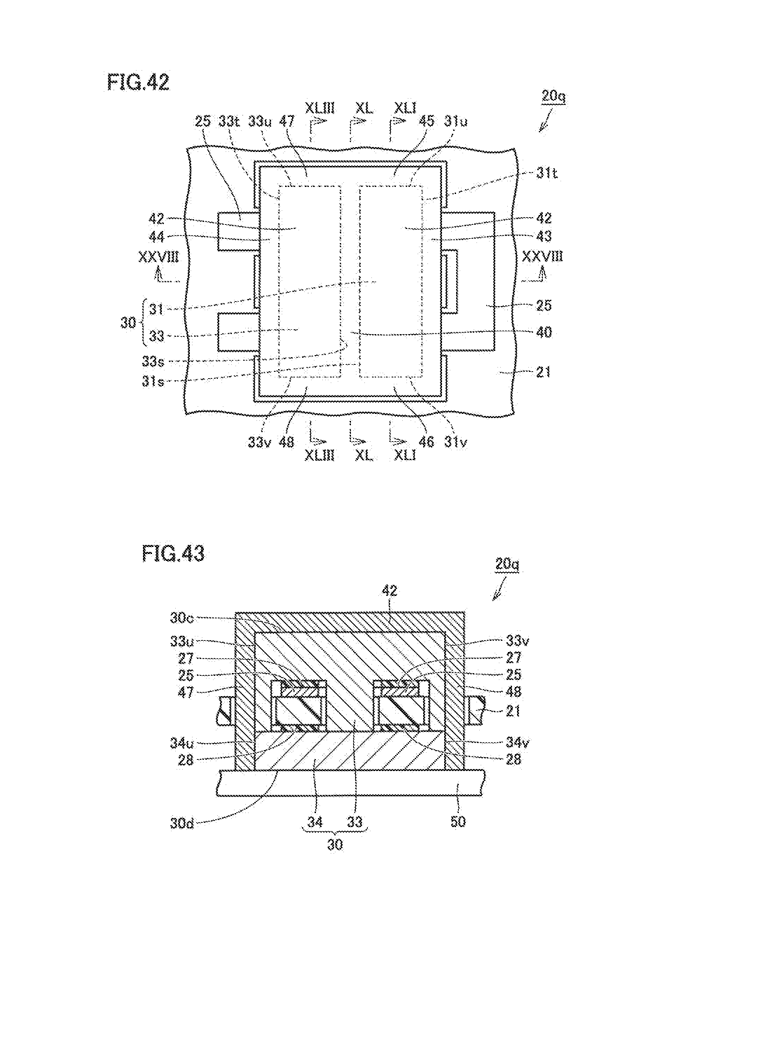

With reference to FIG. 42 and FIG. 43, a circuit apparatus 20q according to embodiment 15 is described. Circuit apparatus 20q in the present embodiment is similar to circuit apparatus 20p in embodiment 14 in configuration but is different from the latter mainly in the following respects.

In circuit apparatus 20q in the present embodiment, first heat transfer member 40 is further in surface contact with the upper surface of second core portion (33, 34) and fourth side surface (33t, 34t), similarly to circuit apparatus 20h in embodiment 8. First heat transfer member 40 includes first extension 42 which is in surface contact with the upper surface of second core portion (33, 34). First heat transfer member 40 includes third extension 44 which is in surface contact with fourth side surface (33t, 34t).

In circuit apparatus 20q in the present embodiment, second core portion (33, 34) further includes seventh side surface (33u, 34u) connecting second side surface (33s, 34s) and fourth side surface (33t, 34t) to each other, and eighth side surface (33v, 34v) connecting second side surface (33s, 34s) and fourth side surface (33t, 34t) to each other and being opposite to seventh side surface (33u, 34u) first heat transfer member 40 is further in surface contact with at least one of seventh side surface (33u, 34u) and eighth side surface (33v, 34v). First heat transfer member 40 may be in surface contact with seventh side surface (33u, 34u) in part or in whole. First heat transfer member 40 may be in surface contact with eighth side surface (33v, 34v) in part or in whole.

First heat transfer member 40 includes a sixth extension 47 which is in surface contact with seventh side surface (33u, 34u). Sixth extension 47 may be in surface contact with seventh side surface (33u, 34u) in part or in whole. First heat transfer member 40 includes a seventh extension 48 which is in surface contact with eighth side surface (33v, 34v). Seventh extension 48 may be in surface contact with eighth side surface (33v, 34v) in part or in whole. First heat transfer member 40 includes at least one of sixth extension 47 and seventh extension 48.

Sixth extension 47 may be thermally connected to heat dissipating member 50. Sixth extension 47 may be in contact with heat dissipating member 50. The heat generated at core 30 is transferred to heat dissipating member 50 through sixth extension 47. Seventh extension 48 may be thermally connected to heat dissipating member 50. Seventh extension 48 may be in contact with heat dissipating member 50. The heat generated at core 30 is transferred to heat dissipating member 50 through the fifth extension. Due to the increase in number of heat dissipating paths for the heat generated at core 30 and the decrease in length of the heat dissipating paths, the rise in temperature of core 30 can be suppressed.

Circuit apparatus 20q in the present embodiment brings about the following advantageous effects. In addition to the advantageous effects of circuit apparatuses 20h and 20p in embodiments 8 and 14.

In circuit apparatus 20q in the present embodiment, second core portion (33, 34) further includes: fourth side surface (33t, 34t) connecting upper surface 30c and lower surface 30d to each other and being opposite to second side surface (33s, 34s); seventh side surface (33u, 34u) connecting second side surface (33s, 34s) and fourth side surface (33t, 34t) to each other; and eighth side surface (33v, 34v) connecting second side surface (33s, 34s) and fourth side surface (33t, 34t) to each other and being opposite to seventh side surface (33u, 34u). First host transfer member 40 is further in surface contact with at least one of seventh side surface (33u, 34u) and eighth side surface (33v, 34v). The area of contact between first heat transfer member 40 and core 30 is increased. According to circuit apparatus 20q in the present embodiment, the rise in temperature of core 30 can be even more uniformly suppressed during operation of circuit apparatus 20q.

In circuit apparatus 20q in the present embodiment, first heat transfer member 40 is further in surface contact with at least one of seventh side surface (33u, 34u) and eighth side surface (33v, 34v). First heat transfer member 40 can reduce the magnetic flux that leaks from core 30 to the electronic components (e.g. secondary-side switching elements 13a, 13b, 13c, 13d or capacitor 14b) Circuit apparatus 20q in the present embodiment can prevent failures and malfunctions in the electronic components (e.g. secondary-side switching elements 13a, 13b, 13c, 13d or capacitor 14b) around circuit apparatus 20q.

### Embodiment 16

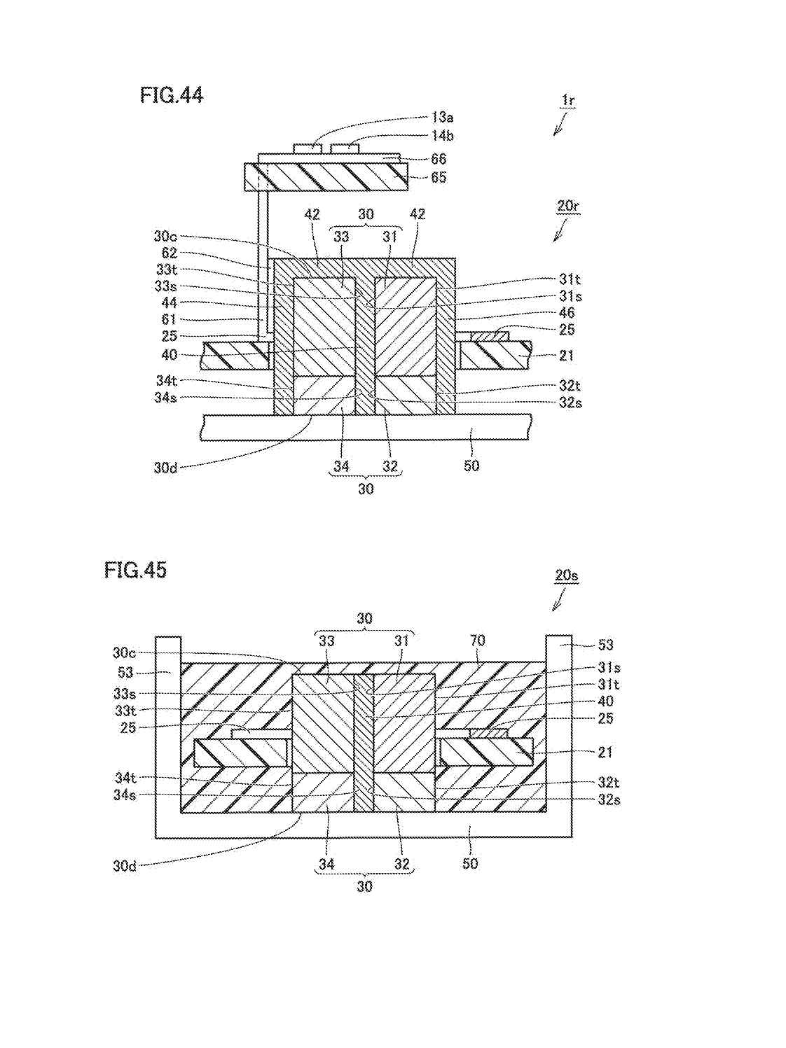

With reference to FIG. 44, a power conversion system 1r and a circuit apparatus 20r according to embodiment 16 are described. Circuit apparatus 20r in the present embodiment is similar to circuit apparatus 20h in embodiment 3 in configuration but is different from the latter mainly in the following respects.

Circuit apparatus 20r in the present embodiment further includes a first interconnect 61 electrically connected to coil 25, and a third heat transfer member 62. First interconnect 61 may be integrated with coil 25. First core portion (31, 32) further includes third side surface (31t, 32t) connecting upper surface 30c and lower surface 30d to each other and being opposite to first side surface (31s, 32s). Second core portion (33, 34) further includes fourth side surface (33t, 34t) connecting upper surface 30c and lower surface 30d to each other and being opposite to second side surface (33s, 34s). First heat transfer member 40 is further in surface contact with at least one of third side surface (31t, 32t) and fourth side surface (33t, 34t).

Third heat transfer member 62 thermally connects first interconnect 62 to first heat transfer member 40 provided on at least one of third side surface (31t, 32t) and fourth side surface (33t, 34t). Specifically, third heat transfer member 62 is sandwiched between first interconnect 61 and first heat transfer member 40 provided on at least one of third side surface (31t, 32t) and fourth side surface (33t, 34t). Third heat transfer member 62 is in surface contact with first interconnect 61, and in surface contact with first heat transfer member 40 provided on at least one of third side surface (31t, 32t) and fourth side surface (33t, 34t). Third heat transfer member 62 has electric insulating properties. Third heat transfer member 62 electrically insulates first interconnect 61 from first heat transfer member 40 provided on at least one of third side surface (31t, 32t) and fourth side surface (33t, 34t).

Third heat transfer member 62 has a higher thermal conductivity than first substrate 21. Third heat transfer member 62 may have a higher thermal conductivity than core 30. Third heat transfer member 62 may have a thermal conductivity of 0.1 W/(m·K) or more, preferably 1.0 W/(m·K) or more, more preferably 10.0 W/(m·K) or more. Third heat transfer member 62 may have rigidity or may have flexibility. Third heat transfer member 62 may have elasticity. Third heat transfer member 62 may be constituted of a rubber material, such as silicone or urethane; a resin material, such as acrylonitrile-butadiene-styrene (ABS), polybutylene terephthalate (PBT), polyphenylene sulfide (PPS), or phenols; a macromolecular material, such as polyimide; or a ceramic material such as alumina or aluminum nitride. Third heat transfer member 62 may be, for example, a silicone rubber sheet.

Power conversion system 1r in the present embodiment further includes: a second substrate 65; a second Interconnect 60 on second substrate 65; and a secondary-side switching element 13a and capacitor 14b electrically connected to second interconnect 66. First interconnect 61 electrically connects coil 25 to second interconnect 66.

Circuit apparatus 20r in the present embodiment brings about the following advantageous effects, in addition to the advantageous effects of circuit apparatus 20b in embodiment 8.

Circuit apparatus 20r in the present embodiment further includes an interconnect first interconnect 61) electrically connected to coil 25, and third heat transfer member 62. First core portion (31, 32) further includes third side surface (31t, 32t) connecting upper surface 30c and lower surface 30d to each other and being opposite to first side surface (31s, 32s). Second core portion (33, 34) further includes fourth side surface (33t, 34t) connecting upper surface 30c and lower surface 30d to each other and being opposite to second side surface (33s, 34s). First heat transfer member 40 is further in surface contact with at least one of third side surface (31t, 32t) and fourth side surface (33t, 34t). Third heat transfer member 62 thermally connects the interconnect (first interconnect 61) to first heat transfer member 40 provided on at least one of third side surface (31t, 32t) and fourth side surface (33t, 34t). The heat generated at coil 25 during operation of the circuit can be transferred to heat dissipating member 50 through the interconnect (first interconnect 61), third heat transfer member 62, and first heat transfer member 40. Third heat transfer member 62 can suppress a local temperature rise of a part of core 30 facing coil 25 due to the heat generated at coil 25 during operation of circuit apparatus 20r. According to circuit apparatus 20r in the present embodiment, the rise in temperature of core 30 can be more uniformly suppressed during operation of circuit apparatus 20r.

In circuit apparatus 20r in the present embodiment, third heat transfer member 62 makes it difficult to transfer the heat generated at coil 25 during operation of the circuit from coil 25 to the electronic components (e.g. secondary-side switching element 13a or capacitor 14b) through the interconnect (first interconnect 61). Circuit apparatus 20r in the present embodiment can reduce the rise in temperature of the electronic components (e.g. secondary-side switching element 13a or capacitor 14b) electrically connected to coil 25 via the interconnect (first interconnect 61).

### Embodiment 17

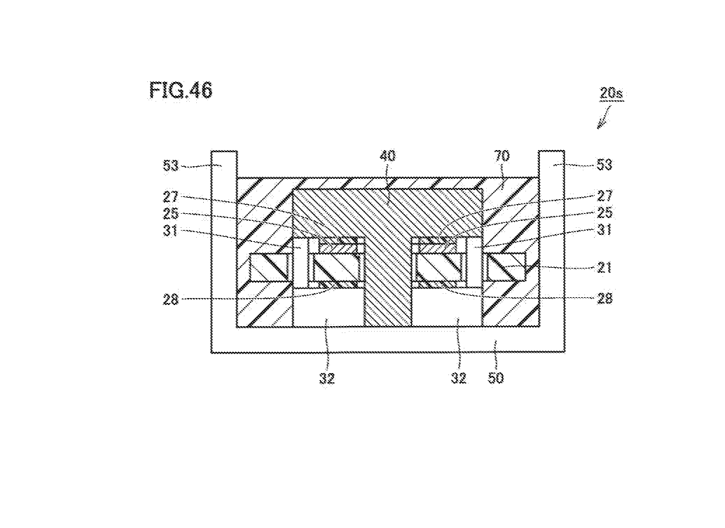

With reference to FIG. 45 and FIG. 46, a circuit apparatus 20s according to embodiment 17 is described. Circuit apparatus 20s in the present embodiment is similar to circuit apparatus 20 in embodiment 1 in configuration but is different from the latter mainly in the following respects.

Circuit apparatus 20s in the present embodiment further includes a sealing member 70 sealing core 30. Sealing member 70 may cover core 30 in part or in whole. Sealing member 70 may be in contact with core 30. Sealing member 70 may position core 30. Sealing member 70 thermally connects core 30 to heat dissipating member 50. Sealing member 70 allows the heat generated at core 30 during operation of circuit apparatus 20s to be transferred to heat dissipating member 50 which has a side wall 53.

Sealing member 70 may also seal first heat transfer member 40. Sealing member 70 may seal first heat transfer member 40 in part or in whole. Sealing member 70 may be in contact with first heat transfer member 40. Sealing member 70 may position first heat transfer member 40. Sealing member 70 may also seal coil 25. Sealing member 70 may be in contact with coil 25. Sealing member 70 may position coil 25.

Sealing member 70 may be constituted of a material having a thermal conductivity of 0.3 W/(m·K) or more, preferably 1.0 W/(m·K) or more. Sealing member 70 has electric insulating properties. Sealing member 70 may have a Young's modulus of 1 MPa or more. Sealing member 70 may be constituted of a resin material having elasticity. Sealing member 70 may be constituted of a resin material such as polyphenylene sulfide (PPS) or polyether ether ketone (PEEK), containing a thermally conductive filler. Sealing member 70 may be constituted of a rubber material, such as silicone or urethane.

Heat dissipating member 50 further includes side wall 53. Heat dissipating member 50 which includes side wall 53 may be a housing. Core 30, first heat transfer member 40, and sealing member 70 may be contained in the housing. Side wall 53 has a height that is 10% or more of the thickness of core 30, preferably not less than the thickness of core 30. In the present description, the thickness of core 30 is defined as the maximum value of the distance between upper surface 30c and lower surface 30d of core 30. Side wall 53 can reduce the magnetic flux that leaks from core 30 to the electronic components (e.g. secondary-side switching element 13a or capacitor 14b). Side wall 53 can prevent failures and malfunctions in the electronic components (e.g. secondary-side switching element 13a or capacitor 14b) around circuit apparatus 20s.

Circuit apparatus 20s in the present embodiment brings about the following advantageous effects, in addition to the advantageous effects of circuit apparatus 20 in embodiment 1. Circuit apparatus 20s in the present embodiment further includes sealing member 70 sealing core 30. Sealing member 70 thermally connects core 30 to heat dissipating member 30. Since the number of the heat dissipating paths for the heat generated at core 30 is increased, the rise in temperature of core 30 can be suppressed.

### Embodiment 18

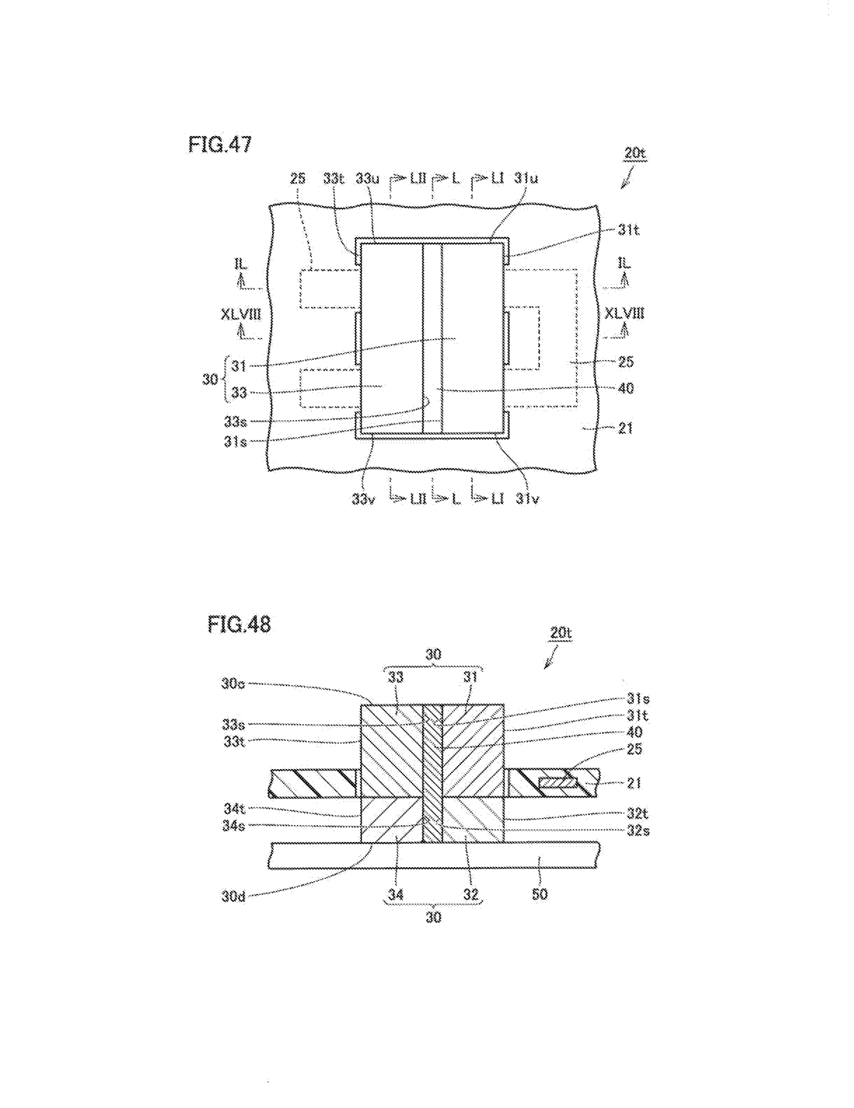

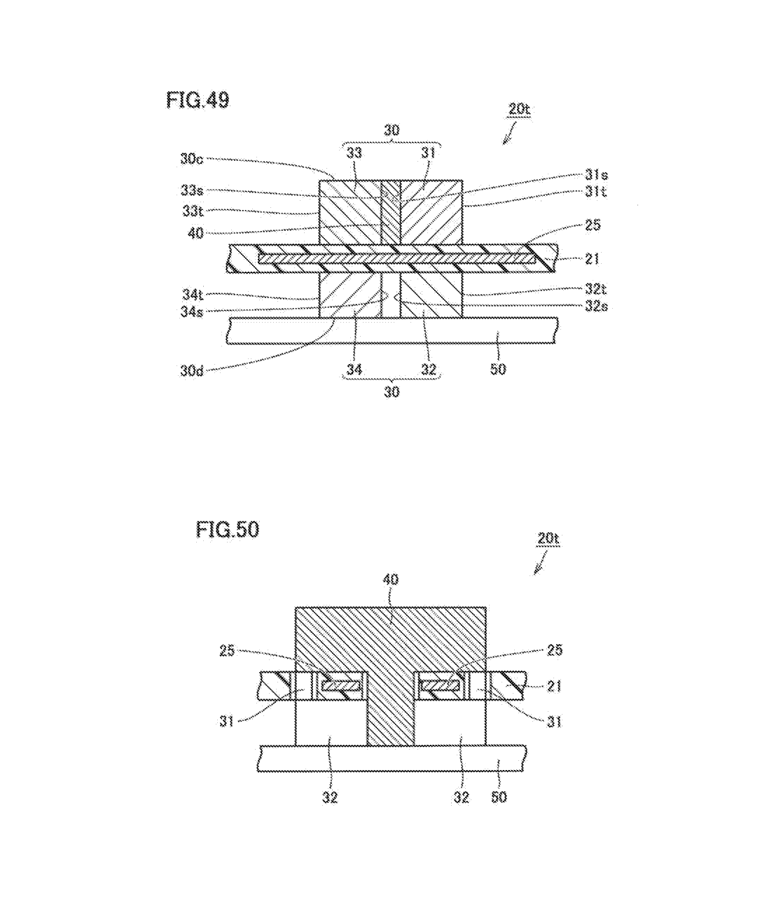

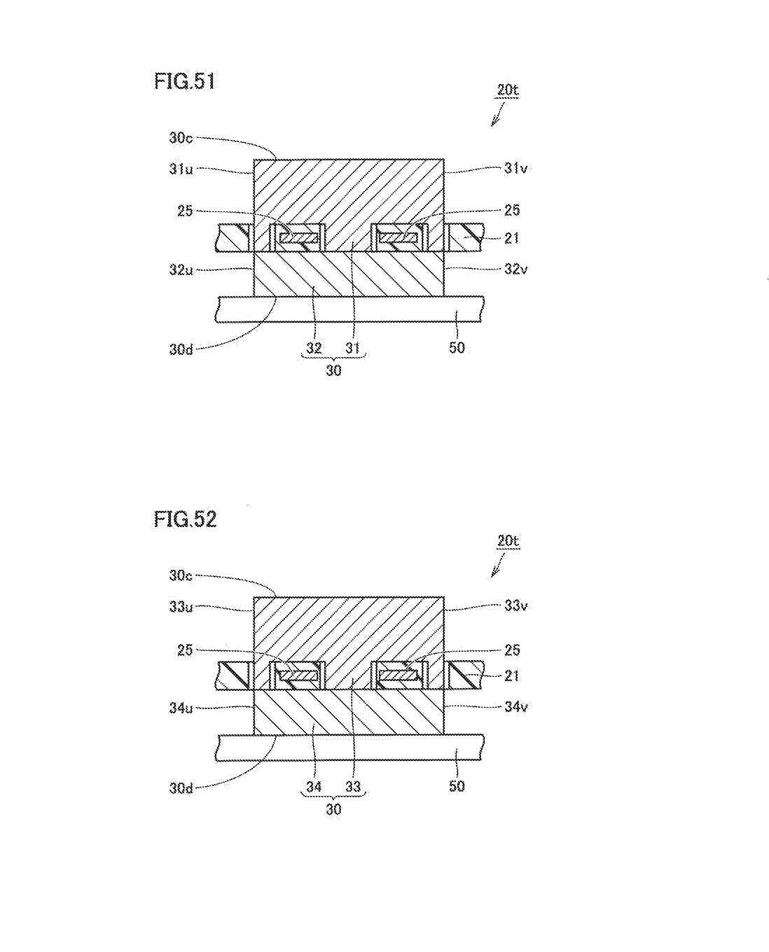

With reference to FIG. 47 to FIG. 52, a circuit apparatus 20t according to embodiment 18 is described. Circuit apparatus 20t in the present embodiment is similar to circuit apparatus 20 in embodiment 1 in configuration but is different from the latter mainly in the following respects.

In circuit apparatus 20t in the present embodiment, coil 25 is provided inside first substrate 21. Coil 25 is arranged between from side 22 and back side 23 of first substrate 21. First heat transfer member 40 is in surface contact with front side 22 of first substrate 21. Core 30 is in surface contact with front side 22 and back side 23 of first substrate 21. Particularly, first core portion (31, 32) is in surface contact with front side 22 and back side 23 of first substrate 21. Second core portion (33, 34) is in surface contact with front side 22 and back side 23 of first substrate 21. First sub-core portion 31 and third sub-core portion 33 are in surface contact with front side 22 of first substrate 21. Second sub-core portion 32 and fourth sub-core portion 34 are in surface contact with back side 23 of first substrate 21.

Circuit apparatus 20t in the present embodiment brings about the advantageous effects similar to those of circuit apparatus 20 in embodiment 1 as described below.

In circuit apparatus 20t in the present embodiment, first heat transfer member 40 is in surface contact with first side surface (31s, 32s) of first core portion (31 , 32) and second side surface (33s, 34s) of second core portion (33, 34). Circuit apparatus 20t in the present embodiment can reduce the difference among a first core temperature at upper surface 30c of core 30, a second core temperature at lower surface 30d of core 30, and a third core temperature at the region between upper surface 30c and lower surface 30d of core 30. Further, in circuit apparatus 20t in the present embodiment, coil 25 is provided inside first substrate 21, and first heat transfer member 40 is in surface contact with first substrate 21. The heat generated at coil 25 during operation of circuit apparatus 20t can be directly transferred to first heat transfer member 40 through first substrate 21. A local temperature rise of a part of core 30 facing coil 25 due to the heat generated at coil 25 during operation of circuit apparatus 20t can be suppressed according to circuit apparatus 20t in the present embodiment, the rise in temperature of core 30 can be more uniformly suppressed during operation of circuit apparatus 20t. Core 30 is prevented from locally having a high temperature, and thus the losses at core 30 such as eddy-current losses and hysteresis losses can decrease.

### Embodiment 19

With reference to FIG. 53 to FIG. 58, a circuit apparatus 20u according to embodiment 19 is described. Circuit apparatus 20u in the present embodiment is similar to circuit apparatus 20 in embodiment 1 in configuration but is different from the latter mainly in the following respects.

Circuit apparatus 20u in the present embodiment further includes second coil 25b. Second coil 25b may be a thin-film coil pattern. Second coil 25b may be a thin conductor layer having a thickness of, for example, 100 μm. Second coil 25b may be a winding. A part of second coil 25b is sandwiched between first sub-core portion 31 and second sub-core portion 32, and between third sub-core portion 33 and fourth sub-core portion 34. Second coil 25b is constituted of a material having a lower electric resistivity than first substrate 21. Second coil 25b may be constituted of a metallic material such as copper (Cu), gold (Au), a copper (Cu) alloy, a nickel (Ni) alloy, a gold (Au) alloy, or a silver (Ag) alloy.

Second coil 25b is provided on back side 23 and surrounds at least a part of core 30. Second coli 25b is supported by first substrate 21. First substrate 21 is a double-sided printed wiring substrate that includes coil 25 on front side 22 of first substrate 21, and second coil 25b on back side 23 of first substrate 21. The state in which second coil 25b surrounds at least a part of core 30 refers to the state in which second coil 25b is wound around at least a part of core 30, a half turn or more. A part of second coil 25b may be sandwiched between first sub-core portion 31 and second sub-core portion 32, and between third sub-core portion 33 and fourth sub-core portion 34. In plan view of coil 25 and second coil 25b, second coil 25b may be formed in the same pattern as coil 25 or may be formed in a different pattern from coil 25.

Second heat transfer member 28 is arranged between second coil 25b and core 30. Second heat transfer member 28 is arranged between second coil 25b and second sub-core portion 32, and between second coil 25b and fourth sub-core portion 34. Second heat transfer member 28 may be in surface contact with second coil 25b and core 30. Second heat transfer member 28 may be in surface contact with second coil 25b, second sub-core portion 32, and fourth sub-core portion 34. Second heat transfer member 28 may be in contact not only with the upper surface of second coil 25b but also with a side surface of second coil 25b. Second heat transfer member 28 thermally connects second coil 25b to core 30. Second heat transfer member 28 has electric insulating properties. Second heat transfer member 28 electrically insulates first heat transfer member 40 from second coil 25b.

First substrate 21 may include thermal vias 29 extending through first substrate 21 from front side 22 to back side 23. Thermal vias 29 thermally connect coil 25 and second coil 25b to each other. Thermal vias 29 have a higher thermal conductivity than core 30. Thermal vias 29 have a higher thermal conductivity than first substrate 21. Thermal vias 29 may have a thermal conductivity of 0.1 W/(m·K) or more, preferably 1.0 W/(m·K) or more, more preferably 10.0 W/(m·K) or more. Thermal vias 29 may have a Young's modulus of 1 MPa or more. Thermal vias 29 may have elasticity. Thermal vias 29 may be constituted of a metal such as copper (Cu), aluminum (Al), iron (Fe), an iron (Fe) alloy (e.g. SUS304), a copper (Cu) alloy (e.g. phosphor bronze), or an aluminum (Al) alloy (e.g. ADC12). Thermal vias 29 may be constituted of a resin material, such as polyphenylene sulfide (PPS) or polyether ether ketone (PEEK), containing a thermally conductive filler.

Thermal vias 29 may have electric conducting properties or may have electric insulating properties. Coil 25 and second coil 25b may be electrically connected in parallel to each other with thermal vias 29 that have electric conducting properties.

Circuit apparatus 20u in the present embodiment brings about the following advantageous effects, in addition to the advantageous effects of circuit apparatus 20 in embodiment 1.

Circuit apparatus 20u in the present embodiment further includes first substrate 21 having front side 22 and back side 23, and second coil 25b. Coil 25 is provided on front side 22. Second coil 25b is provided on back side 23 and surrounds at least a part of core 30. First substrate 21 includes thermal vias 29 extending through first substrate 21 from front side 22 to back side 23. Thermal vias 29 thermally connect coil 25 and second coil 25b to each other.

Accordingly, the heat generated at second coil 25b during operation of circuit apparatus 20u can be transferred to core 30 (second sub-core portion 32 and fourth sub-core portion 34) through second heat transfer member 28, and can be also transferred to first heat transfer member 40 through thermal vias 29, coil 2S, and second heat transfer member 28. A local temperature rise of a part of second coil 25b surrounded by core 30 and a part of core 30 facing second coil 25b due to the heat generated at second coil 25b during operation of circuit apparatus 20u can be suppressed. Circuit apparatus 20u in the present embodiment can reduce the rise in temperature of second coil 25b, and can more uniformly suppress the rise in temperature of core 30 during operation of circuit apparatus 20u.

It should be understood that the embodiments and variations disclosed herein are illustrative in every respect, not limitative. At least two of the embodiments and variations disclosed herein may be combined if compatible. The scope of the present invention is defined not by the above description but by the terms of the claims, and is intended to include any modification within the meaning and scope equivalent to the terms of the claims.

### REFERENCE SIGNS LIST

1, 1r: power conversion system; 10: input terminal; 11: inverter circuit; 11a, 11b, 11c, 11d: primary-side switching element; 12: transformer; 12a: primary-side coil conductor; 12b: secondary-side coil conductor; 13: rectifier circuit; 13a, 13b, 13c, 13d: secondary-side switching element, 14: smoothing circuit; 14a; smoothing coil; 14b, 16: capacitor; 15: resonance coil: 17: output terminal; 18: filter coil; 20, 20a, 20b, 20c, 20d, 20e, 20f, 20g, 20h, 20i, 20j, 20k, 20m, 20n, 20p, 20q, 20r, 20s, 20t, 20u: circuit apparatus; 21: first substrate; 22: front side, 23: back side; 25; coil; 25b: second coil; 27, 28: second heat transfer member; 29: thermal via, 30, 30a: core; 30c: upper surface; 30d: lower surface; 31: first sub-core portion; 31s, 31t, 31u, 31v: side surface; 32: second sub-core portion; 32s, 32t, 32u, 32v: side surface; 33: third sub-core portion; 33s, 33t, 33u, 33v: side surface; 34: fourth sub-core portion; 34s, 34t, 34u, 34v: side surface; 35: fifth sub-core portion; 35s, 35t: side surface; 36: sixth sub-core portion; 30s, 36t: side surface; 40, 41: first heat transfer member; 42: first extension; 42e: first protrusion; 42f: second protrusion; 43: second extension; 44: third extension; 45: fourth extension; 45j, 46j: third protrusion; 46; fifth extension; 47: sixth extension; 48: seventh extension; 48m: fourth protrusion: 50: heat dissipating member; 53: side wall; 60: convection; 61: first interconnect; 62: third heat transfer member; 65: second substrate; 66: second interconnect; 70: sealing member

1. A circuit apparatus comprising:
a core including a first core portion and a second core portion;
a coil surrounding at least a part of the core;
a first heat transfer member arranged between the first core portion and the second core portion;
a heat dissipating member thermally connected to the first core portion, the second core portion, and the first heat transfer member; and
a second heat transfer member having electric insulating properties;
the first heat transfer member having a higher thermal conductivity than the core,
the core including a lower surface facing the heat dissipating member and an upper surface opposite to the lower surface,
the first core portion including a first side surface, the first side surface connecting the upper surface and the lower surface to each other and facing the first heat transfer member,
the second core portion including a second side surface, the second side surface connecting the upper surface and the lower surface to each other and facing the first heat transfer member,
the first heat transfer member being in surface contact with the first side surface and the second side surface,
the second heat transfer member being in contact with the coil and the first heat transfer member and thermally connecting the coil to the first heat transfer member.

2. The circuit apparatus according to claim 1, wherein the first heat transfer member is further in surface contact with the upper surface.

3. The circuit apparatus according to claim 1, wherein the first heat transfer member includes a first protrusion protruding from the upper surface to a side opposite to the lower surface.

4. The circuit apparatus according to claim 2, wherein the first heat transfer member includes a second protrusion protruding from the upper surface along the upper surface.

5. The circuit apparatus according to claim 2, wherein
the first core portion further includes a third side surface, the third side surface connecting the upper surface and the lower surface to each other and being opposite to the first side surface, and
the first heat transfer member is further in surface contact with the third side surface.

6. The circuit apparatus according to claim 5, wherein
the second core portion further includes a fourth side surface, the fourth side surface connecting the upper surface and the lower surface to each other and being opposite to the second side surface, and
the first heat transfer member is further in surface contact with the fourth side surface.

7. The circuit apparatus according to claim 1, wherein
the first core portion further includes:
a third side surface connecting the upper surface and the lower surface to each other and being opposite to the first side surface;
a fifth side surface connecting the first side surface and the third side surface to each other; and
a sixth side surface connecting the first side surface and the third side surface to each other and being opposite to the fifth side surface, and
the first heat transfer member is further in surface contact with at least one of the fifth side surface and the sixth side surface.

8. The circuit apparatus according to claim 7, wherein the first heat transfer member is further in surface contact with the third side surface.

9. The circuit apparatus according to claim 7, wherein
the second core portion further includes:
a fourth side surface connecting the upper surface and the lower surface to each other and being opposite to the second side surface;
a seventh side surface connecting the second side surface and the fourth side surface to each other; and
an eighth side surface connecting the second side surface and the fourth side surface to each other and being opposite to the seventh side surface, and
the first heat transfer member is further in surface contact with at least one of the seventh side surface and the eighth side surface.

10. The circuit apparatus according to claim 9, wherein the first heat transfer member is further in surface contact with the fourth side surface.

11. The circuit apparatus according to claim 7, wherein the first heat transfer member includes a third protrusion protruding from the at least one of the fifth side surface and the sixth side surface along the at least one of the fifth side surface and the sixth side surface.

12. The circuit apparatus according to claim 9, wherein
the seventh side surface is adjacent to the fifth side surface,
the eighth side surface is adjacent to the sixth side surface, and
the first heat transfer member is in surface contact with the fifth side surface and the eighth side surface.

13. The circuit apparatus according to claim 12, wherein
the first heat transfer member includes at least one of a third protrusion and a fourth protrusion,
the third protrusion protruding from the fifth side surface along the fifth side surface, and
the fourth protrusion protruding from the eighth side surface along the eighth side surface.

14. The circuit apparatus according to claim 2, further comprising:
an interconnect electrically connected to the coil; and
a third heat transfer member,
the first core portion further including a third side surface, the third side surface connecting the upper surface and the lower surface to each other and being opposite to the first side surface,
the second core portion further including a fourth side surface, the fourth side surface connecting the upper surface and the lower surface to each other and being opposite to the second side surface,
the first heat transfer member being further in surface contact with at least one of the third side surface and the fourth side surface, and
the third heat transfer member thermally connecting the interconnect to the first heat transfer member provided on the at least one of the third side surface and the fourth side surface.

15. The circuit apparatus according to claim 1, further comprising:
a substrate having a front side and a back side; and
a second coil provided on the back side and surrounding at least a part of the core,
the coil being provided on the front side,
the substrate including a thermal via extending through the substrate from the front side to the back side, and
the thermal via thermally connecting the coil and the second coil to each other.

16. The circuit apparatus according to claim 1, further comprising a sealing member sealing the core,
the sealing member thermally connecting the core to the heat dissipating member.

17. The circuit apparatus according to claim 1, wherein the heat dissipating member is thermally connected to the first heat transfer member at a plurality of portions.

18. A power conversion system comprising the circuit apparatus according to claim 1.
